(19) United States
(12) Patent Application Publication
(10) Pub. No.: US 2008/0120538 A1
(43) Pub. Date: May 22, 2008

(54) Visual web page authoring tool for multi-context web pages

(75) Inventors: Bernd J. Kurz, Fredericton (CA); Beika Zhan, Saint John (CA)

Correspondence Address: STIKEMAN ELLIOTT LLP, 1600-50 O''CONNOR STREET, OTTAWA, ON, KIP 6L2, omitted

(73) Assignee: University of New Brunswick

(21) Appl. No.: 11/798,692

(22) Filed: May 16, 2007

Related U.S. Application Data
(60) Provisional application No. 60/860,403, filed on Nov. 22, 2006.

(51) Int. Cl. G06F 17/00

(52) U.S. Cl. 715/255; 715/200

(57) ABSTRACT

A web page authoring tool apparatus and method are disclosed herein. A user interface module allows an author to manipulatively author at least two context-dependent views of a web page. Each view includes web content. A code page generation module automatically generates a context-aware code page from the context-dependent views of the web page. Rendering cues for presentation of the web page are embedded by the code page generation module according to at least one feature of the web content in each of the at least two context-dependent views, to subsequently aid in at least one of a qualitative aspect of dynamic content adaptation of the context-aware code page and a static content adaptation of the context-aware code page in rendering the web page.

### CROSS-REFERENCE TO RELATED APPLICATIONS

This application claims priority from U.S. Provisional Application No. 60/860,403 filed on May 16, 2006, the entirety of which is hereby incorporated herein by reference.

### MICROFICHE APPENDIX

Not Applicable.

### TECHNICAL FIELD

This application relates to web pages in general, and to a visual web page authoring tool for multi-context web pages in particular.

### BACKGROUND OF THE INVENTION

Mobile computing is becoming ubiquitous since the wide spread of public wireless networks and the popularity of portable computing devices. Nowadays, people can access the Internet wirelessly through many different portable devices such as notebooks, PDAs, and Smartphones. Wireless Access Points, known as “Hot Spots”, are available in most public spaces such as airports, hotels, hospitals, and shopping malls, to provide connectivity to the Internet at any time.

By using the built-in web browsers in the portable devices, users can browse web pages on the World Wide Web conveniently. However, since most web pages are originally designed for desktop computers, they do not fit well on the relatively small portable device screens. Users have to scroll the screen up and down and from left to right to locate the information they want. The situation becomes much more difficult if the web pages contain multiple frames.

The changing of the computing environment brings more problems. Wireless networks use the ether as their transfer medium and the signals are transmitted in the radio spectrum at different frequencies. The available bandwidth becomes narrow in an area where the density of wireless access is high. In addition to this, the processing power and the memory capacity on the portable devices are much lower than on desktop computers. Therefore, a large image would take a long time to be downloaded and rendered on the screen.

Users typically have different browsing preferences. Some of them do not want to show animations, and some do not want to play sound; others might not want to receive any images at all. The difficulty of predicting the behavior patterns of the users leads into another problem with web content delivery.

Context, defined by Dey, is “Any information that can be used to characterize the situation of an entity” (see [8] Dey, A. & Abowd, G., “Towards a Better Understanding of Context and Context-awareness”. Technical Report GIT-GVU-99-22. Georgia Institute of Technology, June 1999, which is incorporated herein by reference). The factors that are mentioned above, including devices, bandwidth, and user preferences, can be realized as the Context of web content delivery. Web pages must be delivered in a Context-aware way in order to achieve efficient delivery and user satisfaction.

The FACADE (FrAmework for Context-aware content Adaptation and DElivery) was developed as an adaptation tool to tailor single-source web pages to the current context (see [1] Kurz, Bernd, and Popescu, Iuli, and Gallacher, Sean, FACADE—A FrAmework for Context-aware content Adaptation and DElivery, CNSR 2004 Proceedings, pp. 46-55; [2] Popescu, Iuli, A Context-Aware Adaptation Framework For Mobile Content Delivery, MCS thesis, University of New Brunswick, July 2004; and [3] Gallacher, Sean, FACADE: Context Information Collection and Transportation For Adaptive Content Delivery, MCS thesis, University of New Brunswick, January 2005; all three of which are incorporated herein by reference). A single-source authored web page is used to contain sufficient information to render the content for varying computing contexts, such as the display size of end user devices and the available bandwidth of the wireless network access. The FACADE framework includes a content server, which contains the single-source authored web pages in XHTML form; an adaptation proxy, which intercepts both web page requests from the end user device and the delivered XHTML page from the content server, adapts the page content given the current computing context by context profiles (device capabilities, network condition, user preferences) [3] that are carried either by the web page request (device, user) or collected by the proxy (network), and forwards the adapted HTML web page to the requesting device [1, 2].

A set of special XHTML extension tags was proposed in the FACADE framework [2]. They are used and embedded in the HTML web pages that serve as rendering cues for the adaptation. However, authoring such single-source web pages and deploying the optional XHTML extension tags require a steep learning curve.

Currently available commercial web page authoring tools, such as Dreamweaver and FrontPage, provide excellent interfaces for authors to create media-rich web page. But these tools do not support the format required for the FACADE framework, and in addition, are not suitable to allow simultaneous authoring for multiple devices. Consequently, at the present time the author has to code multiple single-source web pages manually in a time consuming and error-prone manner. This difficulty has led to research into the development of an authoring tool that introduces as much automation as possible into the XHTML code generation for FACADE multi-context web pages which can be visually created in a WYSIWYG (“What You See Is What You Get”) user interface environment.

### Survey and Analysis of Prior Art Web Page Authoring Tools

Web pages are documents written in HTML code that can be accessed on the Internet. Every web page has a unique address called a URL. Web pages can contain text, graphics, and hyperlinks to other web pages and files. Most web page developers create web pages in two ways: by a text editor or by a WYSIWYG editor. The former requires the developers to have a wide knowledge of HTML, they must write the code manually. The latter does not require understanding of HTML at all, because the code will be taken care of by the program while the developers just need to type text and insert images in the editor window directly. Skilled web page developers usually tend to choose a text editor to do the editing, since they can look into the code and recognize the document structure immediately. Text editors allow developers to write the code precisely and to edit RTML changes quickly. Most importantly, text editors do not add unexpected tags. Beginning web page developers probably tend to choose a WYSIWYG editor instead, for the reason that it is easier to edit in an intuitive interface than to write all HTML code by hand see [5] Dar. Rizwan, Introduction to Extensible HTML 1.0(XHTML), Available at: http://members.tripod.com/˜tickleu/articles/introtoxhtml.htm, Accessed: Jun. 8, 2004, which is incorporated herein by reference).

### WYSIWYG Environment

WYSIWYG stands for “What You See Is What You Get”. A WYSIWYG authoring tool is one that enables users to see on the monitor screen exactly what will appear when the document is interpreted to the desired media. For example, in a word processor, the background usually looks like a sheet of paper. The user is allowed to directly type on the “paper”, change font, format paragraphs, and observe the effect immediately. When the document is finished and printed to paper, it appears exactly as it was on the screen. In a WYSIWYG web page editor, for instance, the author creates the web page in the editing window, and he/she can drag and drop web elements such as tables, images, and forms visually and see the changes instantly. The web page file that is output later will be displayed in a real browser with the same layout it had in the editor window (see [4] Miller, H., Doyle, B., Learn What WYSIWYG Editors Do, Available at: http://www.workz.com/cgi-bin/gt/tpl_page.html,template=1&content=1230&nav1=1&, Accessed: Jun. 30, 2004, which is incorporated herein by reference).

This holds true only if the web browser has at least the same “canvas” size as the original design. The web page layout is still likely to change in a browser with lower resolution. This is why many web pages have a “suggest viewing resolution” writing at the bottom.

### Popular Web Page Authoring Tools

There are many web page authoring tools available on the market. The most common ones are FrontPage 2003, Dreamweaver, CoffeeCup, and Hotdog. They provide excellent interfaces and powerful utilities for authors to create media-rich web pages. The following section will contain a brief description of each of the authoring tools mentioned above, as well as their pros and cons.

### FrontPage 2003

FrontPage 2003 is a product of Microsoft (see [24] Microsoft Corporation, Front page 2003 home, http://www.microsoft.com/office/frontpage/prodinfo/overview.mspx, Accessed: Jun. 10, 2004, which is incorporated herein by reference). It is usually included as part of Microsoft Office. FrontPage resembles Word and other Office products. Thus, FrontPage will be easier and quicker to learn due to its Office-like menus, working areas and site templates (pre-built designs). The site templates will help users to build their web site in minutes; formatting text, inserting images or tables is as easy as using any other word processor, which most people are familiar with. FrontPage uses a tree-structure for all files and folders for organizing a site's structure. Also, if the user has a web page which is linked to many other pages and later renames that file, FrontPage will automatically update links in the other files, and the user will not need to change links manually. For those users who are not familiar with FTP (File Transfer Protocol), FrontPage has a tool that uploads the site through Web Presence Provider (WPP), without the need for an FTP client. If users are using Microsoft Internet Explorer, they can preview their document directly from FrontPage, without starting the browser, making the work easier and quicker to check.

Pros: Usability, familiar environment, text handling features, direct uploading (built-in FTP client), link and Web site management.

Cons: Cannot work with layers (use different layers to present text and images), not many advanced options.

### Dreamweaver

Dreamwcaver is a visual web page editor introduced by Macromedia (see [22] Macromedia Inc, Dreamweaver web page editor, http://www.macromedia.com/software/dreamweaver, Accessed: Jun. 10, 2004, which is incorporated herein by reference). It is one of the most popular web development programs because of its stability and incredible capacity for advanced users. One of the most outstanding features is the possibility of changing between layers and tables. A user can place a layer, with its entire HTML content in any place on the page (absolute positioning). Dreamweaver allows users to design their pages with layers and then it will automatically transform those layers into tables, without losing any of the document's structure. Dreamweaver is compatible with other Macromedia products, such as Flash 5 or Fireworks 4, so creating Flash Buttons or animation text is very easy. It supports image maps (an image with many different links) from a normal image that allows users to create interactive images without any external JavaScript. It supports web page extensions, which means advanced users can create useful add-ons for the editor, from ASP or PHP server side scripting to new HTML tags. Also, it is compatible with the newest web development technologies such as CSS (Cascading Style Sheets), which can be created inside the program. A built-in site management tool for file uploading is also provided.

Pros: Advanced tools, CSS creation, layer and table conversion, Flash and Fireworks integration, interactive images, direct uploading (site management tool) and web page extensions.

Cons: Difficult for beginners, expensive.

### CofffeeCup

The CoffeeCup HTML Editor (see [15] CoffeeCup Software, Inc, CoffeeCup HTML Editor, http://www.cofffecup.com/html-editor, Accessed: Jun. 10, 2004, which is incorporated herein by reference) is a full-featured HTML authoring tool that includes Expresso FTP for uploading and downloading, an image gallery with quick-linking images, a powerful Flash text wizard, highlighted tags, and automatic image sizing. This program comes with more than 25,000 graphics, icons, and photos, including 30 background images, and more than 175 animated GIF images. It also has 125 JavaScript scripts, a frame designer, a table designer, a font designer, and an HTML code cleaner. User also can work on and test multiple pages at once. Other features include an internal browser for testing and editing from the Web, an image-previewing utility, a thumbnail image-creation wizard, a sound gallery, a step-by-step Web design guide, and references for the latest HTML 4.0 tags.

Pros: Includes lots of pre-made graphics, useful JavaScript functions, and different designer wizards. It's free.

Cons: Not supporting visual (WYSIWYG) editing. Too many function buttons make the interface a bit messy.

### HotDog

HotDog is another HTML editor that has all the functionality required for a web page authoring tool (see [29] Sausage Software, LLC, Hotdog web page editor, http://www.sausage.com/hotdog-professional.html, Accessed: Jun. 10, 2004, which is incorporated herein by reference). It supports HTML 4.0 and has plenty of wizards. When the user is typing, it checks the spelling and HTML code to make sure everything is correct. HotDog is mostly suited for beginners, since it has a simple interface, an intuitive tool bar menu, and a friendly help window. HotDog's notable features include a form wizard and “instant” file conversion menus, so users can save a file in Windows, Mac, or Unix format, as well as removing carriage returns, changing backslashes to forward slashes, and so on. It also supports the most the popular languages in modern Web Design (HTML, CSS, PHP, ASP, VBScript, and JavaScript).

Pros: Easy to use, online help window, file conversion, support for many scripting languages.

Cons: Does not support visual editing.

### SUMMARY

According to one aspect of the present invention, there is provided: a web page authoring tool apparatus, comprising: a user interface module for manipulatively authoring at least two context-dependent views of the web page, each view including web content; and a code page generation module for automatically generating a context-aware code page from the at least two context-dependent views of the web page; wherein rendering cues for presentation of the web page are embedded by the code page generation module according to at least one feature of the web content in each of the at least two context-dependent views, to subsequently aid in at least one of a qualitative aspect of dynamic content adaptation of the context-aware code page and a static content adaptation of the context-aware code page in rendering the web page.

According to another aspect of the present invention, there is provided: a web page authoring tool method, comprising the steps of: providing a user interface module for manipulatively authoring at least two context-dependent views of the web page, each view including web content; and providing a code page generation module for automatically generating a context-aware code page from the at least two context-dependent views of the web page; wherein rendering cues for presentation of the web page are embedded by the code page generation module according to at least one feature of the web content in each of the at least two context-dependent views, to subsequently aid in at least one of a qualitative aspect of dynamic content adaptation of the context-aware code page and a static content adaptation of the context-aware code page in rendering the web page.

Other aspects and features of the present invention will become apparent to those ordinarily skilled in the art upon review of the following description of specific embodiments of a visual web page authoring tool for multi-context web pages in conjunction with the accompanying drawing figures.

### BRIEF DESCRIPTION OF THE DRAWINGS

Embodiments of the present invention will now be described, by way of example only, with reference to the accompanying drawing figures, wherein:

FIG. 1 shows an overview of the FACADE framework;

FIG. 2 shows how data is exchanged among different components in the FACADE framework;

FIG. 3 lists the editing methods that the WebBrowser control supports;

FIG. 4 shows the adaptation of program APIs;

FIG. 5 is an example of Absolute Positioning using CSS;

FIG. 6 illustrates an example of a table containing the two images shown in FIG. 5;

FIG. 7 illustrates the flowchart of how the GI/XHTML engine generates single-source code;

FIG. 8 lists the objects in the editor window (shown in FIG. 9) with their attributes;

FIG. 9 shows an editor window;

FIG. 10 is an example that shows what the code skeleton looks like;

FIG. 11 is an example that shows what the PDA ext tags look like;

FIG. 12 illustrates the relationship of four components in one embodiment;

FIG. 13 illustrates one embodiment of the user interface of the web-authoring tool;

FIG. 14 illustrates in greater detail the toolbar of FIG. 13;

FIG. 15 is a visual representation of a project file;

FIG. 16 shows three simple web pages that were created on the device windows of FIG. 13;

FIGS. 17-19 illustrate an example single-source XHTML code output;

FIG. 20 is the screen shot of the adaptation result for the desktop page;

FIG. 21 is the screen shot of the adaptation result for the PDA page and the Smartphone page;

FIGS. 22a-c illustrate the web page code generated for the Desktop, PDA and Smartphone devices in HTML format respectively;

FIG. 23 shows a device window which is editing on a page with many objects;

FIG. 24 shows the web page rendered on a desktop web browser using nested tables with a hidden border,

FIG. 25 shows the web page rendered on a desktop web browser using nested tables with a visible border; and

FIGS. 26-36 show an example code page of the nested tables shown in FIGS. 23-25.

### Like reference numerals are used in different figures to denote similar elements.

### DETAILED DESCRIPTION OF THE DRAWINGS

A new tool is needed for generating the XHTML single-source web pages. The existing web authoring tools do not satisfy our needs because they do not deal with extension tags and simultaneous authoring for multiple devices. A graphical authoring tool would facilitate single-source authoring of adaptable web pages and provide automation. It would allow authors to create web pages more quickly and avoid coding errors.

The new web page authoring tool will provide WYSIWYG visual editing. Users can interact with the program interface directly, as well as drag and drop objects. It is capable of simultaneous authoring for multiple devices and has multiple windows for desktop, PDA, and Smartphone. Users build smaller and simpler Smartphone and PDA pages from media-rich desktop pages. When the web page layout is satisfactory, users can automatically generate the XHTML code in the code preview window and output it as a single-source file.

One object of the present invention is to provide a web page authoring tool to help authors to create single-source web pages of the FACADE type where the tool converts a graphical interface to XHTML code.

There are several approaches to accomplish content adaptation. In the early stage, multi-authoring was used as an initial approach towards context-aware development. Web page designers create separate pages for a variety of clients: each version must be individually maintained and updated. Due to the high development and maintenance cost, single-source authoring was introduced to web content adaptation and it suggested that one single-source authored document is to contain sufficient information to render the content for different end user devices [2]. In this approach, the development and maintenance effort can be reduced. Other benefits include efficient use of bandwidth and improved application usability.

The FACADE framework [1, 2, 3] promises to provide an overall solution to content adaptation using a single-source authoring approach and proxy-side adaptation techniques. Disclosed herein is some information that is related to the FACADE framework. The mechanism of the adaptation of single-source document will also be presented.

### FACADE Framework Overview

The FACADE framework consists of a content server that contains web pages in XHTML form with extension tags, a proxys server that sits between the content server and clients to perform adaptation, a profile server that acts as repository to hold context profiles, and the end user devices that receive adapted web pages in HTML form from the proxy server.

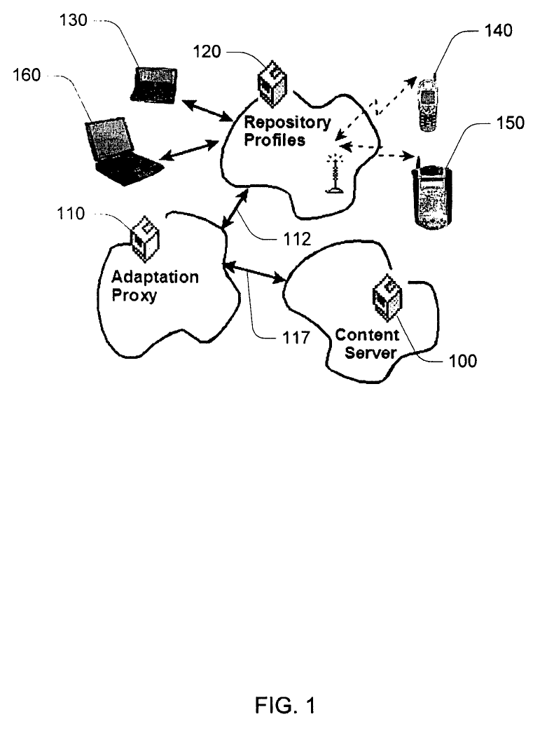

FIG. 1 shows an overview of the FACADE framework. The Content Server 100 uses single-source authored web content that is created in XHTML format with additional extension tags. These extension tags serve as rendering cues for different presentations and are embedded within the web content. They are inserted according to the semantics, relevance and layout of content, and subsequently aid in maintaining semantic fidelity and usability in dynamic content adaptation. The extension tags that were proposed in the FACADE framework include the following:
Allow adaptation (Yes/No). It specifies content that allows adaptation or not. Some information may have copyright issues and cannot be modified, so this kind of content must be delivered in its original form;
Content relevance. It specifies the importance of certain blocks of content. Some content might have lower priority compared to others and is not shown on devices with smaller screens;
Adaptation unit specification. It specifies the granulation of information in small adaptation units. Content within an adaptation unit is targeted for a specific device;
Pagination. It specifies rules on how individual adaptation units can be grouped to form pages. Each page will have a page identifier;
Navigation. It specifies links between pages that can be semantically linked. For small devices, the navigation link normally points to the previous page or next page;
Inclusion/exclusion. It specifies what content is to be included or excluded based on different context parameters:
Selection tags. It specifies alternatives for the original content. A color logo might have a grey scale alternative for a mono screen. A full paragraph text might have a shortened summary for smaller devices [2].

The proxy server 110, which combines a CIE (Context Information Engine) and CAE (Content Adaptation Engine) deals with both web page requests from the client side 112 and the delivered XHTML content from the server side 117. The CAE dynamically adapts the content to specific clients 130, 140, 150, 160 given the current computing context. Context information, which includes device capabilities, network conditions, and user preference, is specified in profiles. Profiles are stored in a separate profile server 120 and are represented in CC/PP (Composite Capabilities/Preferences Profiles) format. End user devices can be any desktop computers (not shown), notebooks 130, 160, PDAs 150, and Smartphones 140 that have a web browser installed.

### Adaptation Process

The CAE is the most important component in the FACADE framework. It is the place where adaptation is performed and content is cached. The performance of downloading content can be improved by caching, through which the requested server content is stored temporarily at the proxy. Therefore, if the context has not changed, subsequent request for that content can be retrieved at the proxy, instead of contacting the server again, thus saving time and bandwidth.

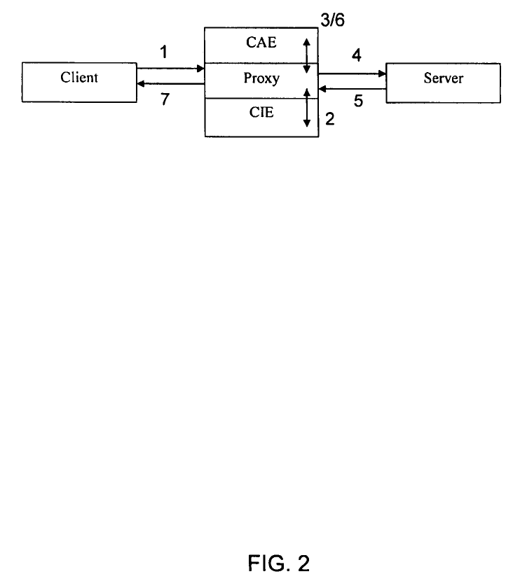

FIG. 2 shows how data is exchanged among different components in the FACADE framework. The arrows represent the direction of the data flow and the numbers indicate the order of that particular process.
1. The Client first sends the HTTP request to the server and the request is intercepted by the Proxy. The HTTP request header contains certain information about the device, network and user.
2. The Proxy passes the request header to the CIE component, where the header information is parsed and the profile is obtained. The request is then forwarded back to the Proxy.
3. Once the CC/PP profile is resolved, the client request and the profile are sent to the CAE, where the request will be modified according to certain profile parameters. Next, the modified request is returned to the Proxy (depending on context, the request might not always be modified).
4. The Proxy forwards the (possibly modified) client request to the content server, and starts waiting for the response.
5. The Content server sends back the response with appropriate content. The response includes a single-source authored document that is in XHTML format with extension tags. The content might include images, videos, and sound; however, if a profile via a modified server HTTP request indicates to omit these media file types, they will not be transferred.
6. After receiving the response, the Proxy passes all the content in the response to the CAE. The CAE performs adaptation according to the profiles it received at step 3. Only the content that is suitable for the current context will be delivered.
7. Proxy delivers the modified content to the client. The documents are in regular HTML format [1, 2].

The FACADE framework enables efficient delivery of Internet content to mobile device users. However, the difficult authoring of single-source document is obviously the most significant drawback of the entire architecture.

### Requirement Analysis

Due to the disadvantages with the prior art web authoring tools described above, there is a need for a new visual web page authoring tool. However, in order to gain familiarity with web authoring, known web page editors have been studied to see which functions could be retained in the new visual authoring tool. The user interfaces, menus and toolbar layouts also can be adopted in order to give users a familiar editing environment. Another important task is the investigation of the way the editors provide the user with visual editing capabilities in terms of drag and drop, absolute positioning, and image resizing. CoffeeCup and HotDog are not preferred due to the lack of support for visual editing. Frontpage and Dreamweaver both provide a MDI (Multiple Document Interface) interface and allow users to control objects that are on the screen in a WYSIWYG manner. After comparing many aspects of Frontpage and Dreamweaver, such as usability and functionality, as well as considering the requirements of the new visual authoring tool, a list of design decisions were made and a set of required functionalities were identified. They are listed below.

Overall Layout:
The new visual authoring tool is created as a MDI application, allowing a parent window to contain multiple child windows;
The parent window includes a drop down menu, allowing the users to choose the editing function that they want;
The parent window has a toolbar, which provides some frequently used buttons such as font, color, bold, underline, italic, and alignment;
A status bar has been created at the bottom of the parent window to give users useful information about the current status of the application;
Three device windows are used for three pre-selected devices such as desktop PC, PDA, and Smartphone. The desktop window is relatively large and can be placed on the top left of the parent window. The PDA and Smartphone windows are relatively small and can be placed to the right of the desktop window.
A code window displays the web page code in real time. This code window can be placed at the lower part of the parent window;
PDA and Smartphone windows can have a set of buttons that allow users to manipulate pagination.

Editing Functions:
The visual authoring tool provides basic web page editing functions such as changing font, changing color, hold, italic, underline, and justify (left, center, and right);
It provides the ability to insert images;
It provides the ability to insert textboxes, which allows users to enter text;
It provides the ability to insert Hyper-links.

User Operations:
Enable single or multiple objects to be selected. Selected objects should be highlighted (i.e., to have a bold and highlighted edge);
Enable drag and drop operations, allowing the user to move an image or a text box across device windows by holding and releasing the left mouse button;
Enable resizing of images and textboxes;
Enable the extension device tags and pagination tags to be automatically embedded;
Enable unfinished jobs to be saved as project files and loaded at a later time;
Enable right mouse clicking to bring up a context menu.

### Visual Basic.NET

Visual Basic is a visual programming environment from Microsoft that is used for developing Windows applications (see [26] Microsoft Corporation, Visual Basic Home, http://msdn.microsoft.com/vbasic, Accessed: Jun., 10, 2004, which is incorporated herein by reference). Visual Basic makes it possible to develop practical programs very quickly. The programmer designs Windows forms graphically, and then drags program elements represented by icons from the Visual Basic Toolbox, followed by writing code for each element. Visual Basic is event-driven; procedures are called automatically when the end users choose a menu item, press the keyboard, click the mouse, move objects on the screen, etc. The interface is very friendly and intuitive; even programmers who use other programming languages can easily adapt. Visual Basic runs relatively slower than Visual C++, because VB programs compile at the run time and use many ActiveX controls that consume additional CPU cycles. In recent years, Visual Basic has evolved into Visual Basic.NET (VB.NET), a fully OOP language. Just like C++ and Java, it also supports object classes, interfaces, information hiding, data encapsulation, inheritance, and polymorphism.

Pros: Easy to use, develops GUI applications faster, supports classes and objects.

Cons: Runs relatively slow, difficult to use for low-level hardware operations.

VB.NET also supports reuse of the Internet Explorer control. However, it does not provide as much flexibility as VC.NET. In VB.NET, a WebBrowser control is included, which encapsulates the MSHTML control and provides basic web page editing and display functions (see [19] Kumiawan, Budi, Object Oriented Programming for VB.NET, [Internet], http://www.devasp.net/net/search/display/category292.html, Accessed: Jun. 10, 2004, which is incorporated herein by reference). The WebBrowser control can contact a remote Web server, download an HTML file and render it onscreen. When the WebBrowser control is in editing mode, the control will accept user input such as inserting text and inserting images. Some functions that it supports are listed below:
Supports different fonts, colors, and style;
Supports images links, and tables;
Supports paragraph alignments;
Supports WYSIWYG editing;
Supports absolution positioning.

Since these functions are all needed to build the new visual authoring tool, the WebBrowser control becomes a good candidate for this project. A more detailed description for the WebBrowser control follows.

### The WebBrowser Control

The WebBrowser control is one of the controls installed with VB.NET, which is nothing less than a complete browser disguised as an ActiveX control. Technically, it's a wrapper around Internet Explorer that can be hosted in a Windows form. The WebBrowser control adds browsing, document viewing, and data downloading capabilities to Windows applications. Applications using this control will allow the user to browse sites on the Internet's World Wide Web, as well as folders in the local file system and on a network. The HTML content is downloaded and is rendered on the screen. Moreover, in addition to showing HTML documents, the WebBrowser control exposes a Document property, which returns an object that represents the current document. Using the Document property, programmers can access the structure and all the components of a loaded document, including the document's images, links, or even create a new document on the fly and display it on the control.

The parsing and rendering of HTML documents in the WebBrowser control is handled by the MSHTML component of Microsoft Internet Explorer 4.0 or later. The MSHTML component is an Active Document (also known as a DocObject) that provides support for parsing and rendering HTML, exposes the Dynamic HTML (DHTML) Object Model and hosts Microsoft ActiveX Controls and script languages.

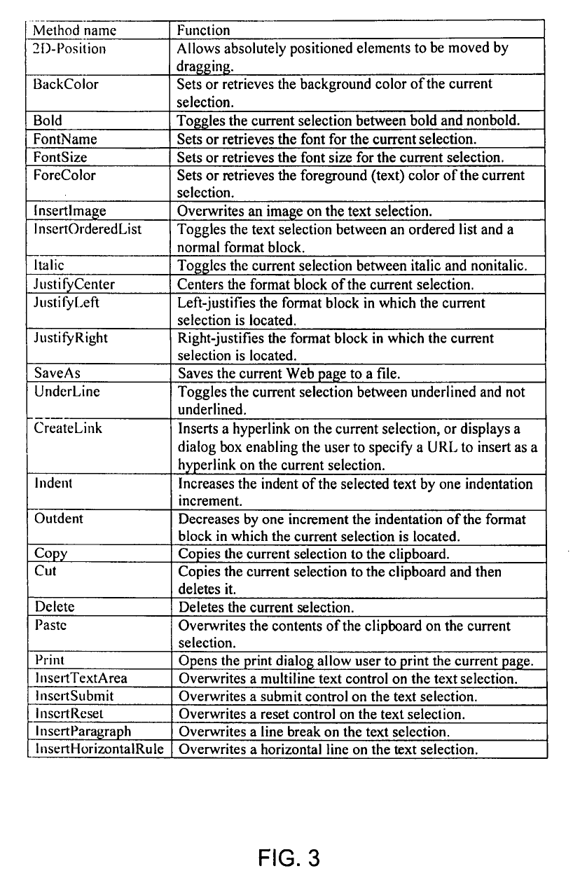

To use the WebBrowser control on a Windows form, programmers must first add it to the VB Toolbox and drag it to the desired location on the form. To navigate to a URL, use the control's Navigate method, which accepts the desired URL as an argument. To start editing a web page, use the control's document object and set its design Mode property to “On”. When the WebBrowser control is in design mode, it begins to accept user input from the keyboard and mouse. The user can type a paragraph of text and start editing it. FIG. 3 lists the editing methods that the WebBrowser control Supports.

These are built-in methods that are supported by the WebBrowser control. Many of them are very straightforward and ready to be used. By applying these methods to the Windows application that hosts the WebBrowser control it is possible to build a fully functional WYSIWYG web page editor with almost all common editing features.

### Top-Down Approach

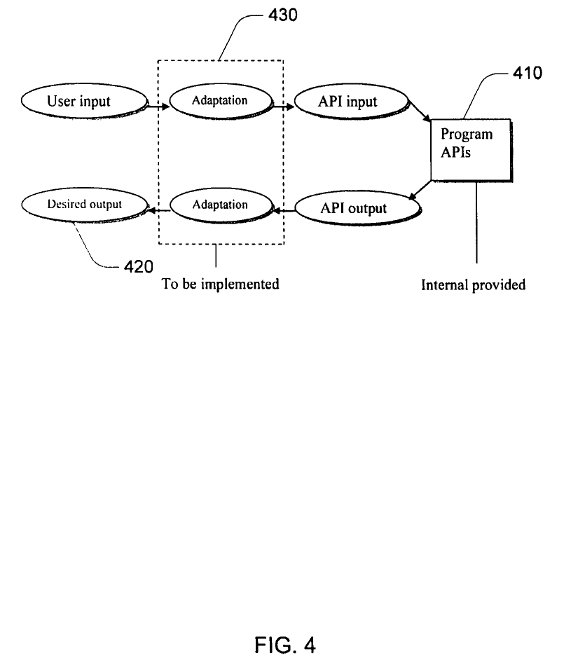

FIG. 4 shows the adaptation of program APIs. The GI/XHTML engine was built using the top-down approach, in which programmers utilize program APIs 410 or adapt class libraries that provide the desired functions. For example, VB.NET already includes the WebBrowser control that is capable of rendering 420 HTML elements on the screen. Programmers can adapt 430 these rendering methods and customize them into their own application thus saving implementation time.

### Absolute Positioning

Since the visual editor should provide WYSIWYG-editing capabilities, one important attribute that needs to be implemented is absolute positioning, which allows users to move and place objects on the screen anywhere they want. In order to keep track of the positions of objects shown on the screen, there is a set of x and y coordinates associated with them. When an object is moved, or it is reoriented, the GI/XHTML engine analyzes the new position and outputs the corresponding XHTML code that reflects the actual position where the object will be displayed on a web browser, regardless of the resizing of the browser window. The GI/XHTML engine uses the nested table method. In the method, the positions of on-screen objects are placed into a nested table. The table must be calculated and generated dynamically and the sizes of cells must change according to the relative location of different objects.

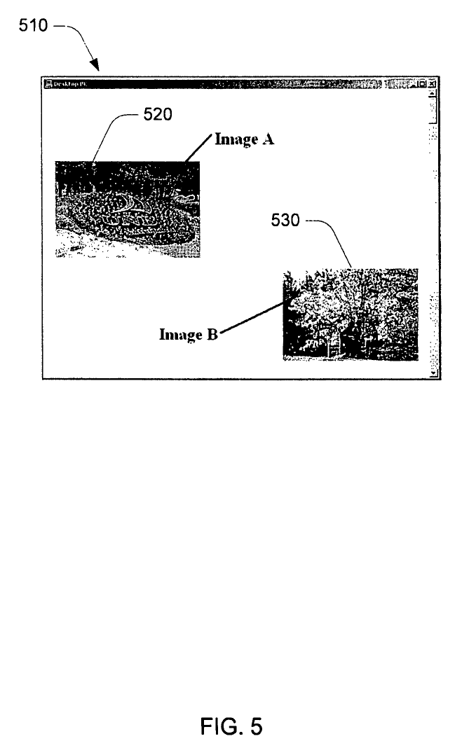

FIG. 5 is an example of Absolute Positioning using CSS. Assume there are two images in the editor window 510, Image A 520 and Image B 530. The coordinates (x and y of the upper-left point of the image, expressed in pixels) for Image A is (47, 184), and for Image B is (488, 328).

To display this simple page in a regular web browser, the editor needs to output the code below:

<html>
<head><title> </title>
</head>
<body>
<img src=“imageA.jpg” style=“position:absolute; left:47px; top:184px”>
<img src=“imageB.jpg” style=“position:absolute; left:488px; top:328px”>
</body>
</html>

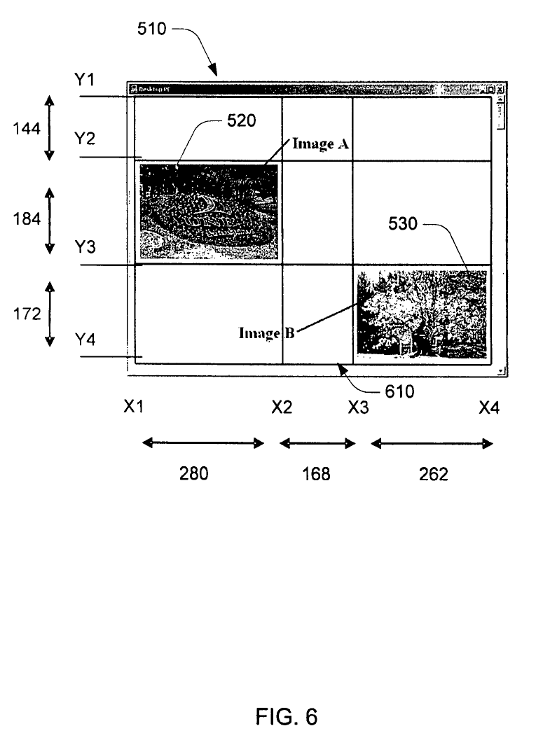

FIG. 6 illustrates an example of a table containing the two images shown in FIG. 5. This figure shows that the two images were nicely placed into a three by three table 610. This table will need to be converted into HTML code in order to be recognized by web browsers. To make the table invisible to the users, we can just set the border attribute of the table to zero. The challenge here is to come up with an algorithm that can be used to generate the table dynamically.

To calculate the table 610, the first step is to obtain the object list. From the list we need to get the size and position for each object. In this example we have four values for x positions and four values for y positions (X1 . . . X4, Y1 . . . Y4, in FIG. 6). Using these values, a table 610 of three columns and three rows can be easily produced. The next step is to put the images 520, 530 into corresponding cells. This is done by comparing the position ranking of each object. For instance, coordinates for Image B 530 are (448, 328); 448 is represented by X3 and 328 is represented by Y3 in the figure. Therefore Image B 530 should be placed in the third column and third row. Similarly, the ranking for Image A 520 is X1 and Y2, so Image A is placed in the first column and second row. The HTML code for the table and these two images looks like this:

```
<html>
<head><title> </title></head>
<body>
<table width=“710” height=“500” border=“0”>
    <tr height=“144”>
      <td width=“280”></td>
      <td width=“168”></td>
      <td width=“262”></td>
    </tr>
    <tr height=“184”>
      <td valign=“top” width=“280”><img src=“imageA.jpg” /></td>
      <td width=“168”></td>
      <td width=“262”></td>
    </tr>
    <tr height=“172”>
      <td width=“280”></td>
      <td width=“168”></td>
      <td valign=“top” width=“262”><img src=“imageB.jpg” /></td>
    </tr>
</table>
</body>
</html>
```

Since the <table> tag is a standard element of HTML 4.01, it is well supported by almost all web browsers including the compact ones on PDAs. One drawback of this approach is that if there are too many images on the screen, the table will be divided into many small cells and therefore the code will be very long and hard to read. However since this is automatically generated by the GI/XHTML engine, the process is transparent to authors, so it is not a major issue.

In conclusion for the purpose of implementing absolute positioning, the CSS approach (of using absolute positioning,) is good for generating concise HTML code but lacks support by PDAs. The Nested Table approach is good for providing compatibility among all kinds of web browsers but it produces cumbersome code. One object of this invention is to allow simultaneous authoring for multiple devices; therefore, compatibility must be considered first. In this case the Nested Table approach is more appropriate than the CSS approach and was chosen for the implementation.

Another example featuring numerous objects is described further below under the heading NESTED TABLE EXAMPLE.

### Automated Process

The GI/XHTML engine plays a very important role in the automated process of code generation. Extension tags insertion is done behind the scenes and does not require author intervention. Among all the extension tags that were proposed by the FACADE framework, only two types are used in the UniWeb project (an alternate name for one embodiment of the authoring tool of the invention). One is the device tag, which specifies the end user device type that the web page will be displayed on. There are three categories of device tags: desktop PC, PDA, and Smartphone. The other is the pagination tag, which indicates page numbers and provides navigation to next/previous pages.

### Generating Single-Source Documents

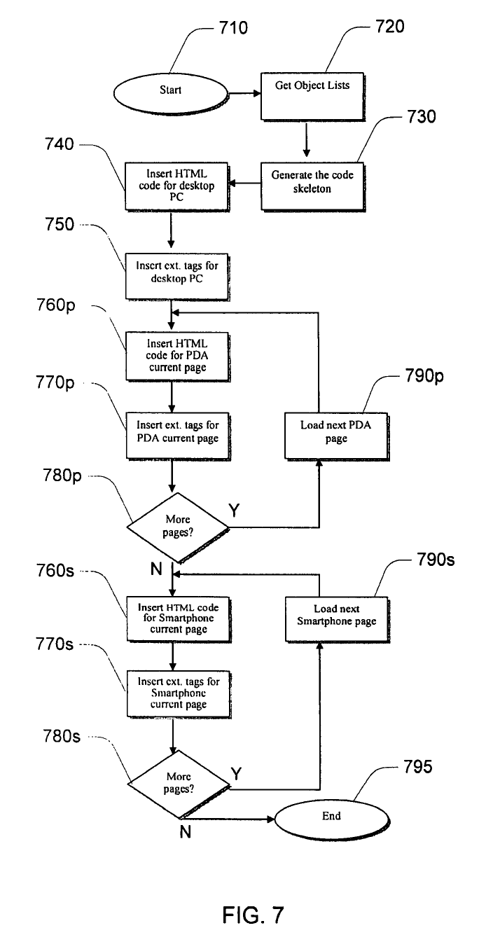

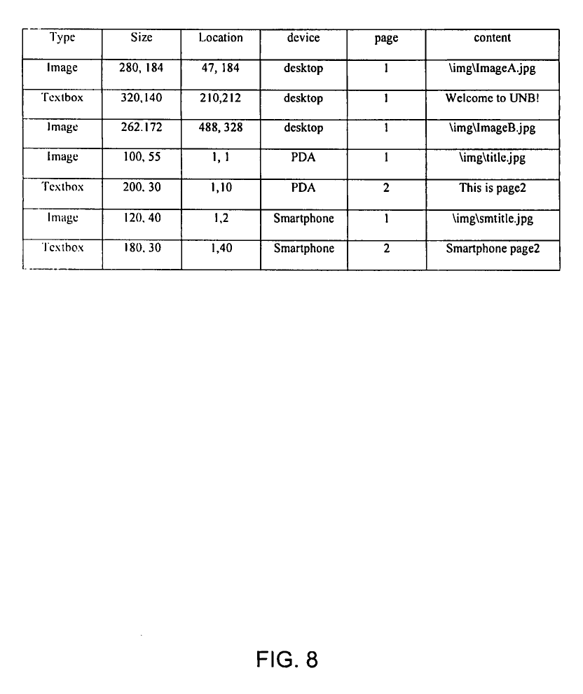

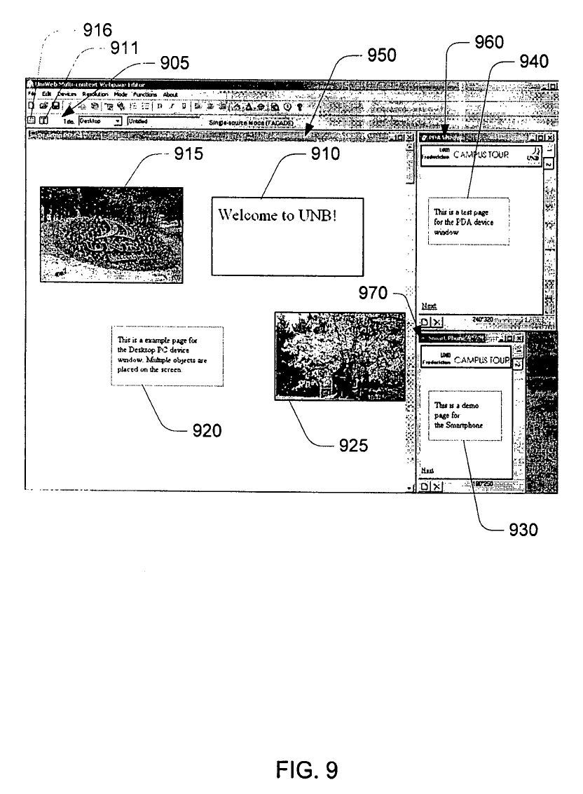

FIG. 7 illustrates the flowchart of how the GI/XHTML engine generates single-source code. The processes start 710 by obtaining the object list 720 from the Object Container (a class in memory that the authoring tool uses to store objects). The Object Container is another important component in the program that acts as a repository for storing on-screen elements. Next, the objects in the object list will be extracted and analyzed; this includes their attributes such as object type, size, location, device type, page number, contents, and so on. For example, FIG. 9 shows an editor window and FIG. 8 lists the objects in the editor window (shown in FIG. 9) with their attributes.

The Image 915, 925 and Textbox 910, 920, 930, 940 are added to the device window 950, 960, 970 by clicking the corresponding insert button 916, 911 on the toolbar. They are drawn on the screen using VB's built-in system draw methods. Mouse events are associated with these objects (Image and Textbox), and when an object is dragged it is erased and redrawn continuously, and this gives the user the feeling that the object is “moving”. Every textbox 910, 920, 930, 940 wraps a WebBrowser control that serves as a small text-rendering tool. When a textbox is double-clicked, it activates the WebBrowser control that is hidden behind the textbox. The user can type directly in the WebBrowser control and edit the text style.

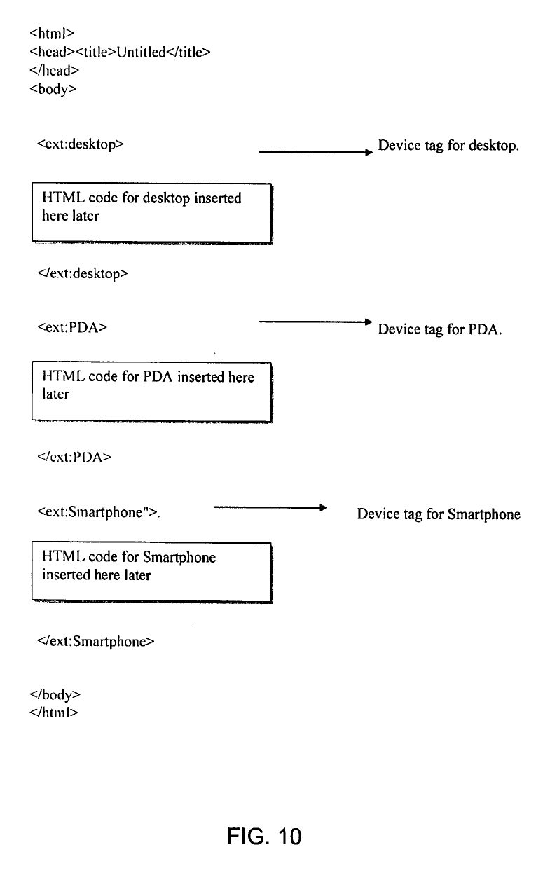

After all attributes of the objects are retrieved, the GI/XHTML engine generates a code skeleton 730 which includes web page header tags and extension device tags. FIG. 10 is an example that shows what the code skeleton looks like.

The next step 740 is to generate HTML code for the desktop and insert it into the corresponding section in the code skeleton. Absolution Positioning takes place in this process, in which the GI/XHTML engine calculates and produces a nested table to hold all of the objects on the desktop window (Refer to Absolute Positioning section).

At step 750 the ext tags for desktop PC is inserted.

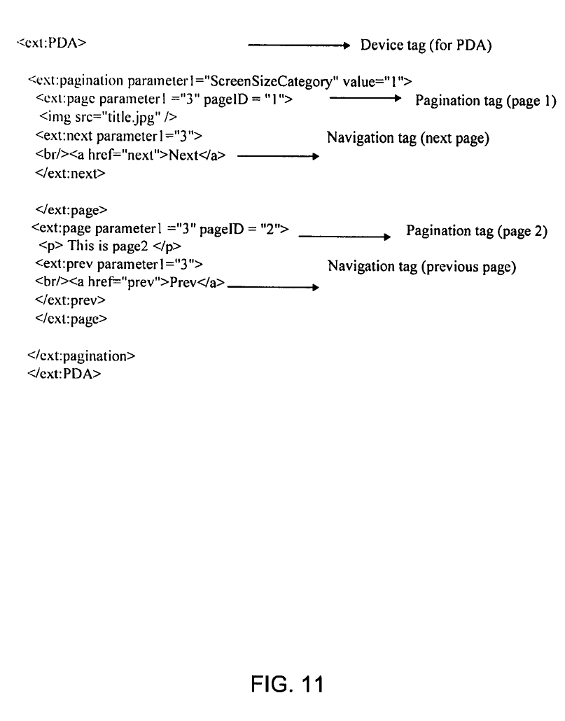

After the desktop code is finished, the following process is used to generate the code for the PDA, followed by generating code for the Smartphone. The difference here is that the PDA and the Smartphone may have more than one page (desktop has only one page); therefore the process involves inserting the pagination and navigation tags which allow a large-size web page to be paginated without scrolling up and down. Paginated web pages are linked together by the navigation tags, one for the previous page and one for the next page. The insertion is automatically completed each time a new page is added. FIG. 11 is an example that shows what the PDA ext tags look like. The simple code example for the PDA window shown contains two pages.

Analogous steps take place for the other devices (PDA, Smartphone), iterating through the pages for those devices. At steps 760p and 760s the HTML code for the PDA and Smartphone respectively at the current page are inserted. At steps 770p and 770s the ext tags for the PDA and Smartphone respectively at the current page are inserted. At steps 780p and 780s a determination is made as to whether or not there are more PDA and Smartphone pages respectively. If so determined, at steps 790p and 790s the next PDA and Smartphone page respectively are loaded and steps 760p-770p and 760s-770s are repeated for the next PDA and Smartphone page respectively.

When the entire process is completed 795, the editor outputs a complete single-source document in text format. The single-source file will be saved with “.xhtml” extension name. All of the images will be saved in the folder where the single-source file resides.

### Generating Multi-Source Documents

Another editing mode of the UniWeb editor is the multi-source mode which generates separate web pages for different devices that can be used in the common WWW environment. The documents that were generated under multi-source mode do not incorporate any of the extension tags, so they do not require being adapted in order to be shown on the web browser.

In single-source mode, the WebBrowser control is wrapped in a textbox. If the device window contains multiple textboxes, then each textbox will contain an individual WebBrowser control to deal with the formatting of text within that particular textbox. Extension tags were added outside each WebBrowser control. In multi-source mode, since we do not need to be concerned about extension tags, therefore only one WebBrowser control is sufficient for each device window. The WebBrowser control is stretched to fill the entire device window.

In single-source mode, users create additional pages if the content can not fit in one page (PDA and Smartphone). In multi-source mode, since there is no pagination (extension tag) support, each device window contains only one page. However, scrolling is available to allow users to add as much content as they want. A vertical scroll bar will enable users to view the content from top to bottom.

Each device window will output an individual web page file in regular HTML format for the content that it contains. For instance, three HTML files will be generated for desktop PC, PDA, and Smartphone, respectively. Since most Web servers support HTML files, these multi-source documents that are generated by the authoring tool are suitable as standard web pages.

### Implementation of the Web Page Authoring Tool

The Multi-context Visual Webpage Authoring Tool was developed under the VB.NET environment. The tool includes the following functionality: basic web authoring features, object drag and drop, image resize, absolute position, pagination, navigation, automatic tag embed, file save and load, and XHTML code generation. It will be understood by those skilled in the art that tables, buttons, radio controls, combo boxes, and web forms can also be included.

### Program Architecture

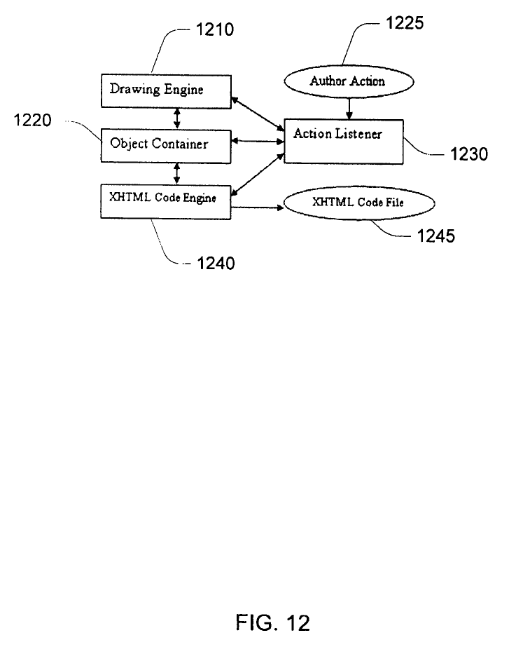

FIG. 12 illustrates the relationship of four components in one embodiment. The main program consists of four major components: the Drawing Engine 1210, the Object Container 1220, the Action Listener 1230, and the GI/XHTML Code Engine 1240.

### Action Listener

The Action Listener 1230 is responsible for recording every interaction 1225 of the author with the device windows. These actions include object drag and drop, movement of objects, resizing of objects, text entry, and general object editing. When the author performs an action, a corresponding system event occurs and an event handler is triggered. The Action Listener 1230 implements the event handlers that deal with different operation requests. When an action is recognized and validated, the Action Listener forwards the action request to the related program component. Here is a list of events that the Action Listener 1230 will handle:
Mouse Click: When the author clicks a mouse button on the device window, a mouse click event occurs. The Action Listener 1230 captures the event and then forwards the click point and the clicked mouse button as arguments to the Object Container 1220. Next, the Object Container 1220 determines if any objects were being selected by the click point and tells the Drawing Engine 1210 to highlight it if so. If the right mouse button is clicked, a context menu will be displayed.
Mouse Down: The Mouse Down event occurs when the author holds down a mouse button. There are two states in this event: object selected and no object selected. The Drawing Engine 1210 and the Object Container 1220 need to know these two states in order to perform corresponding actions.
Mouse Move: The Mouse Move event occurs when the author holds down a mouse button and moves the mouse. If an object is selected, it will be continuously redrawn during the mouse move event; if no object is selected, a rectangular select box will appear, allowing multiple objects to be selected.
Mouse Up: The Mouse Up event occurs when the author releases a mouse button. It happens when a move operation or a resize operation is finished. The selected object will obtain a new position or a new size according to the action performed.
Drag Enter: The Drag Enter event occurs when an object is dragged into a device window. If the object is newly created, the Action Listener 1230 informs the Object Container 1220 to store this object. Otherwise, if the object is moved from one device window to another, the Object Container 1220 will be asked to change the ownership attribute of the object. After the Object Container 1220 finishes its job, the Drawing Engine 1210 draws it on the new device window. The Drag Enter event needs to know the Ctrl key states in order to determine if an object is being moved or being copied. For instance, copy is performed in a Drag event when an object is moved into another device window with the Ctrl key pressed down.
Drag Leave: The Drag Leave event occurs when an object is dragged out from a device window. Similar to the Drag Enter event, the Action Listener 1230 contacts the Object Container 1220 to indicate that an object no longer belongs to a certain device window. Also, the Drawing Engine 1210 is instructed to erase the object from the screen.
Drag Over: The Drag Over event occurs when an object is dragged and moved around inside a device window. The location of the object is continuously updated as well as its appearance.
Drag Drop: The Drag Drop event occurs when an object is dropped. The event signifies the end of a drag and drop operation.
Key Down: The Key Down event occurs when a key is pressed on the keyboard. This event includes two states. The first one is typing state, in which the author types characters; the second one is command state, in which the author hits a command key or combination of control keys to perform commands. For example, the author can hit the Backspace or Delete key to erase characters, hit the F1 key to display help, hold the Ctrl key and C to perform copy, hold the Ctrl key and V to perform paste, and so on.

### Drawing Engine

The Drawing Engine 1210 implements all drawing methods and carries out the actual drawing of objects on the editor window for a particular device. The Drawing Engine 1210 has three drawing targets; they are the desktop device window, the PDA device window, and the Smartphone device window, respectively.

Before an editor window can be drawn, The Drawing Engine 1210 needs to obtain its System Graphic Object. By applying drawing methods on the System Graphic Object, The Drawing Engine 1210 can draw points, lines, shapes, and images directly in the editor window.

### Object Container

The Object Container 1220 acts as the repository which stores the objects that are placed on the various device windows, along with their relevant attributes, such as location coordinates, object type, size, color, and text. Normally, all objects are encapsulated in input boxes. Thus, all predefined web page editing functions inherent to the input box, such as text editing, color and font selection, and image resizing, are available to the author to manipulate the web page object held by the input box. The input box not only acts as a sub-container to store text, but is also capable of extracting regular HTML code for the objects within it.

### GI/HTML Code Engine

The XHTML Code Engine 1240 generates XHTML code 1245 dynamically whenever the user requests it. Extension tags are embedded inside the XHTML code 1245. This process is all automated and does not require user intervention. The code generation can operate in two modes. As a code generator for single-source web pages to be used with the FACADE infrastructure, the HTML extension tags are embedded automatically as necessary. However, the code engine can also be instructed to generate individual HTML code files, one for each of the device windows used. This allows the multi-context visual web page authoring tool to be used for the simultaneous authoring of multi-source web pages for use in the common non-adaptive WWW environment.

### Authoring Tool Functionality

Editing functions that are implemented in the new authoring tool include the following:

1. Basic web page editing functions such as changing font, changing color, bold, italic, underline, and justify (left, center and right).

2. The ability to insert Hyper-links.

3. The ability to insert images

4. The ability to insert textboxes, which allow users to enter text.

The WebBrowser control, which already offers all basic editing functions, is incorporated into the program thus reducing the implementation effort. By deploying it, the first and second requirements in the list above are fulfilled.

Two supporting classes are implemented for image and textbox manipulation. These two classes have some common behaviour so they can be extended from an abstract class through inheritance. The abstract class here is called Glyph which defines common attributes for images and textboxes such as location, size, and the actions that can be performed on them. The actions include:
Hit Detection: A Glyph must tell the main program if it is selected by the mouse. A given point is sent to the Glyph each time a mouse click occurs. If the point is within the Glyph or on the edges, the Glyph should return “hit=true”. Otherwise if the point is outside then it should return “hit=false”.
Draw screen: A Glyph must be able to contact the Drawing Engine to draw itself on the screen. It has access to the system drawing methods and the memory pointer to the drawing target. It knows the location and the content to be drawn.
Draw highlight: A Glyph should become highlighted when it is selected. This is done by drawing a thick dark rectangle around its edges.
Erase screen: A Glyph must inform the Drawing Engine to erase it when it is deleted, or to redraw it when it is moved to a new location.
Return content: A Glyph must be able to return its content to the main program. For instance, an image should return its file path and file name, and a textbox should return the text string it contains.
Relocate: A Glyph must be able to move to a new location when given new coordinates.
Resize: A Glyph must be able to resize itself when given a new set of dimensions.

The “draw screen”, “erase screen”, and “return content” methods are overridden by both the image class and the textbox class, since they perform these actions differently.

### Graphical User Interface (GUI)

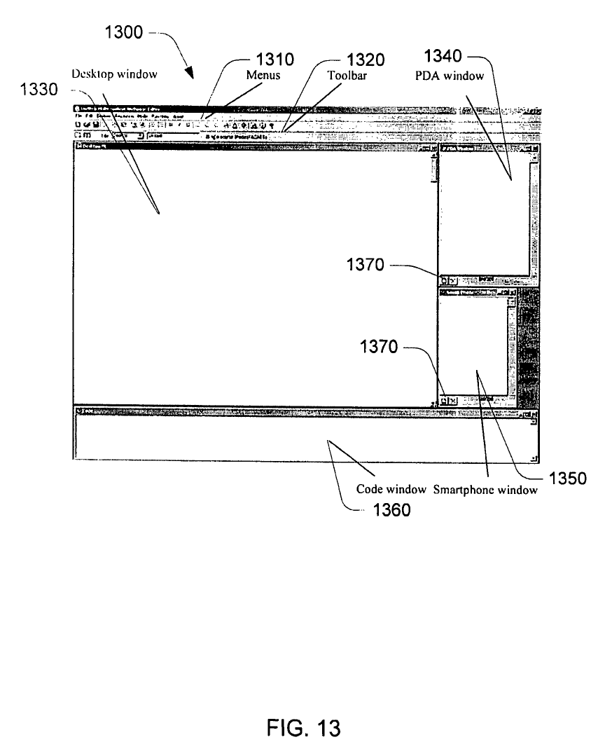

FIG. 13 illustrates one embodiment of the user interface of the web-authoring tool. The user interface of the new authoring tool is created similar to those well-known web page editors, such as Frontpage and Dreamweaver, except for the addition of multiple device windows, in order to give the user a familiar authoring environment. The program interlace is composed of a parent window and four sub-windows. Menus and toolbar are located on the parent window. The sub-windows are the desktop window, the PDA window, the Smartphone window and the code window. The overall layout includes:
The Visual Authoring Tool is created as a MDI application, allowing a parent window 1300 containing multiple child windows;
The parent window 1300 contains drop-down menus 1310, allowing the user to choose the editing function he/she wants;
The parent window 1300 has a toolbar 1320, which includes some frequently used buttons such as font, color, bold, underline, and italic.
A status bar is provided in the menu bar or alternatively at the bottom of the parent window to show application status (not shown);
Three device windows are created for three pre-selected devices: desktop 1330 PC, PDA 1340, and Smartphone 1350;
A code window 1360 is created for displaying the web page code in real time. This code window 1360 is placed at the lower part of the parent window 1300;
PDA 1340 and Smartphone 1350 windows contain a set of buttons 1370 that allow users to manipulate pagination.

### Menus

There are seven sub-menus under the menu bar: File, Edit, Device, Resolution, Mode, Functions, and About.

The File menu includes options for file operations such as create a new document, open a document, save documents, load web page, load URLs, and close documents.

The Edit menu includes basic operations for text editing such as undo, redo, copy, cut, paste, delete, select all, and unselect. These functions can be selected when the text box is in input mode.

The Mode menu contains three options for opening and closing the desktop, PDA, and Smartphone windows. When a device window is closed, it can be reopened by clicking its device name under this menu.

The Resolution menu includes options for changing the resolution for each of these three devices. The resolution settings will be automatically saved in a configuration file when the program exists.

The Mode menu contains two options: Single-source mode and Multi-source mode. The Single-source mode is for editing web pages of the FACADE format, while the Multi-source mode is for editing web pages in regular HTML format. Editing mode can be changed dynamically during the authoring process.

The Functions menu includes most common web page editing functions such as changing fonts, colors, alignments, and style, and adding hyper-links, horizontal rules, bookmarks, text fields, select boxes, radio boxes, and buttons. All editing functions under the Function menu are inherited from the WebBrowser control.

The About menu contains help, which shows the user manual, and about, which shows the program copyright and version information.

### Tool Bar

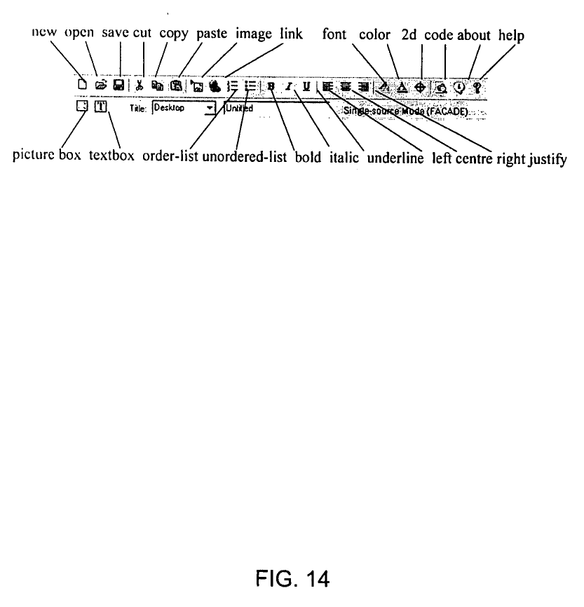

FIG. 14 illustrates in greater detail the toolbar of FIG. 13. The toolbar includes functions that the user will use most frequently.

### Device Windows

Three device editor windows are added to the parent form as MDI child windows. Each one represents a specific device. The Desktop PC window, for example, accepts input from the user by means of keyboard events and mouse events. The drawing engine also draws the output directly on the device editor window.

### User Interactions

Users can interact with the program interface in many ways. There are two major input categories: mouse input and keyboard input.

### Object Selection

Users can select an object by simply clicking on the object. This interaction is manipulated by the mouse-click event handler:
Object Move: Users can move an object by holding down the left mouse button. Both the mouse-down and mouse-move event handlers will together control this interaction.
Multiple Object Selection: Users can select multiple objects at once by dragging a rectangular selection box over the objects that need to be selected. A hit detection handler will check which objects are selected by the selection box.
Edit: Users can double click a text box to start edit its content. The double-click event handler will take care of this interaction.
Copy: Users can copy an object from a device editor window and paste it into another device editor window. The clipboard will temporally store the object until another copy command is performed.
Delete: Users can delete objects that are no longer needed by highlighting the object and pressing the Delete key or Backspace key. The object will be removed from the object list and erased on the screen.
Drag and Drop operations: Users can perform drag and drop operations such as dragging an object from the toolbar to a device window and dragging object edges to different sizes. Drag and drop operations are governed by a series of drag and drop event handlers.
Saving project file: Users can save the program status into a project file. The project file is saved in the hard disk with “.unw” extension. When the project file is reloaded, the program status will be restored and users can continue their unfinished work.

There were initially two approaches to save program status. One approach is using serialization to serialize the objects in the memory and store them in binary files. The benefit of using serialization is the convenience of saving an object on disk and loading it back to the memory. However, in order to use serialization, the class must implement the serialization interface. If the class does not implement the serialization interface or does not support serialization, then the objects of this class cannot be serialized. At times an object might include a reference to another object; in this case, the second object must also implement the serialization interface in order to make the first object serializable. In other words, an object is serializable only if all of its children are serializable.

In one embodiment, if the Object Container can be serialized then the problem is solved. This is because the Object Container includes all objects that determine the program states. However, the Object Container also includes a reference to the WebBrowser control, which is not serializable. This means that the serialization approach is not suitable for this project.

Another approach is extracting attributes from objects and saving them in text format. These attributes are later read from the text file and used to initialize the objects that need to be restored in memory. A parser must be implemented to traverse through the object list and record all object attributes such as object type, location, size, content, and owner.

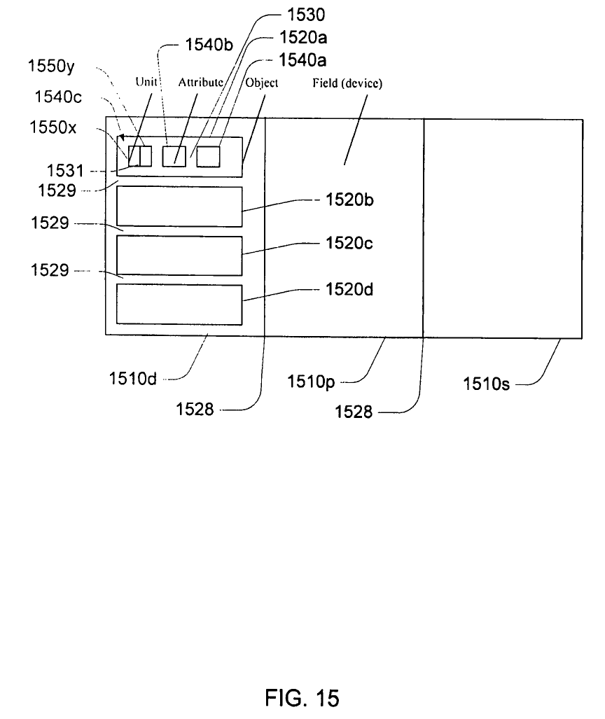

The second approach is more appropriate than the first one since text file and the object parser are easy to implement. The structure of the text file is defined as follows (FIG. 15 is a visual representation of a project file):
The text file is divided into 3 fields 1510d, 1510p, 1510s; each field represents a device and the fields are separated by a special ASCII control character 1528 (28, FS). The first field 1510d is defined to be the desktop, the second field 1510p is defined to be the PDA, and the third field 1510s is defined to be the Smartphone.
Each field 1510d is sub-divided into many objects 1520a-d; each object 1520a-d is separated by a special ASCII control character 1529 (29, GS). The objects can be textboxes, images, and their combinations.
Each object 1520a is sub-divided into many attributes 1540a-c; each attribute 1540a-c is separated by a special ASCII control character 1530 (30, RS). Attributes include object type, location, size, content, and owner.
Each attribute 1540c is sub-divided into two or more sub-units 1550x,y. For example, the location attribute 1540c could be sub-divided into two integers: one for x 1550x and one for y 1550y. Sub-units are separated by a special ASCII control character 1531 (31, US).

Four different ASCII symbols are sufficient to separate the information of the text file, which has four levels of data hierarchy. This text file is treated as the project file. When the project file is reopened, the number of objects that will be recreated is identical to the number of object fields in the project file. The attributes of each object will be restored by the data read from the attribute field.

### Evaluation

The authoring tool was evaluated by examining a single-source XHTML code generated by the code engine, including the code structure, code correctness, and extension tags. The XHTML code was uploaded to the FACADE content server and tested on the FACADE test client. The multi-source mode was also tested. The purpose was to see how the non-adaptable web pages (also generated by the code engine but without extension tags) will show on real devices.

### Single-Source Mode

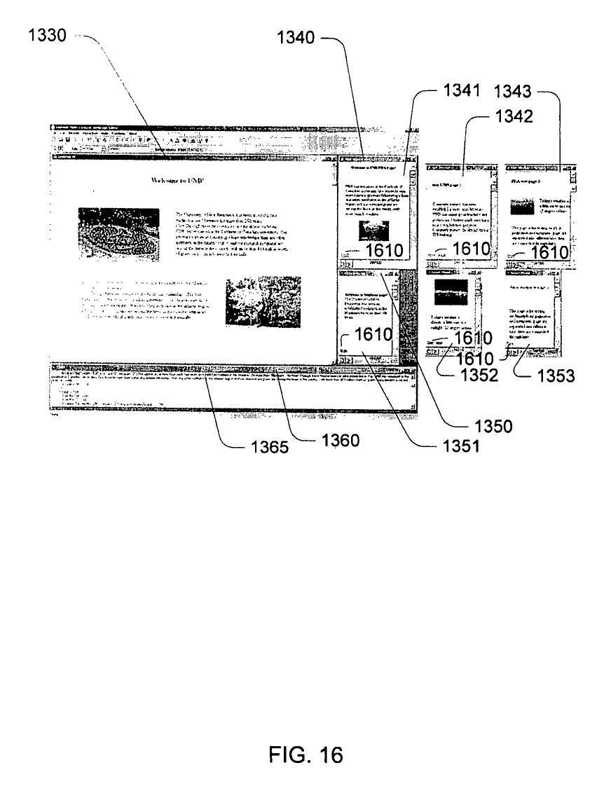

FIG. 16 shows three simple web pages that were created on the device windows of FIG. 13.

The PDA 1340 and Smartphone 1350 device windows each contain three pages 1341, 1342, 1343 and 1351, 1352, and 1353 respectively. Every page is linked to the previous or next page by a navigation hyperlink 1610. The XHTML, code 1365 is displayed in the code preview 1360 window dynamically.

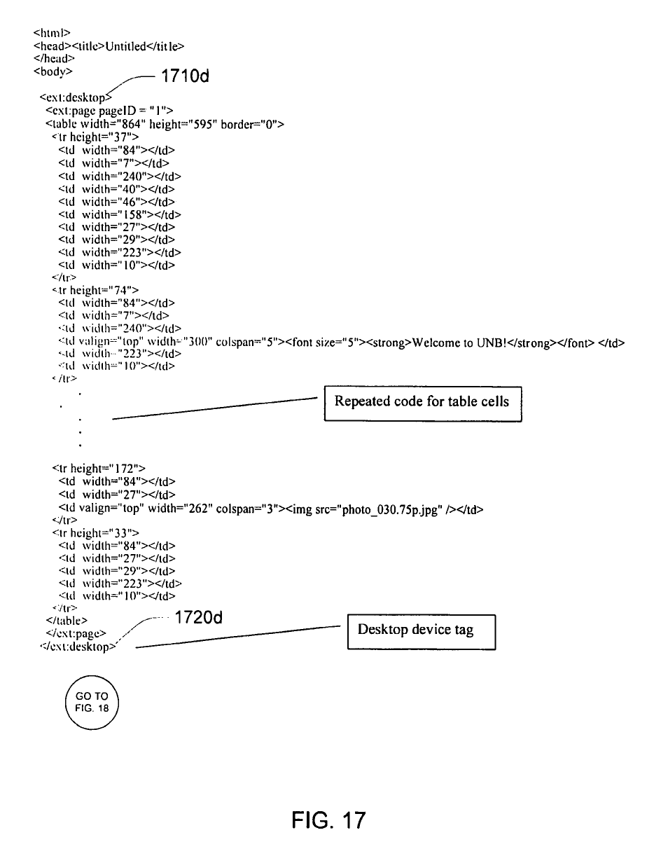

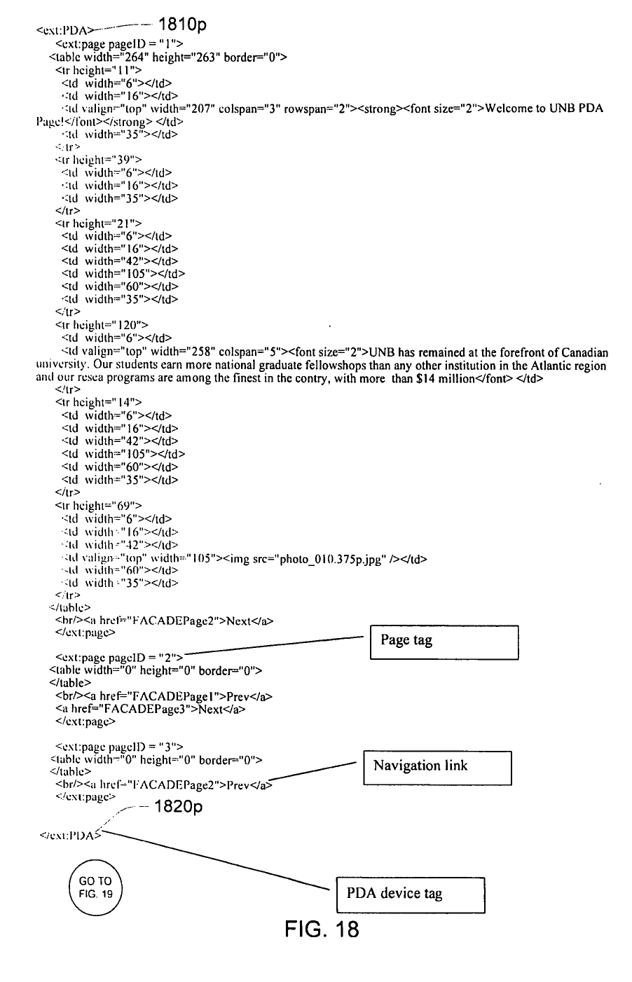

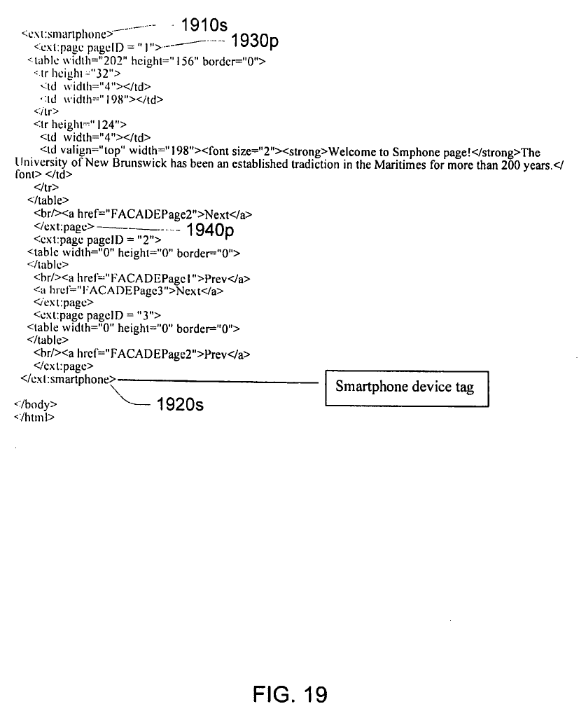

FIGS. 17-19 illustrate an example single-source XHTML code output. The code is divided into three sections with each section (see FIG. 17, FIG. 18, and FIG. 19 respectively) enclosed by a pair of device tags 1710d, 1720d; 1810p, 1820p; 1910s, 1920s respectively. For example, the PDA code (FIG. 18) is enclosed by “<next:PDA>” 1810p and “</ext:PDA>” 1820p. Similarly, the content for a page is enclosed by a pair of page tags 1930p, 1940p. The page tag includes a parameter named “pageID”, which indicates the page number. The navigation tags use hyperlinks to point to the previous or next page.

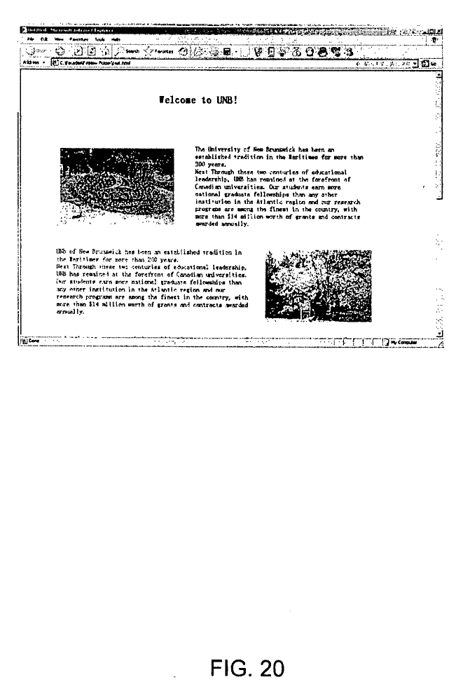

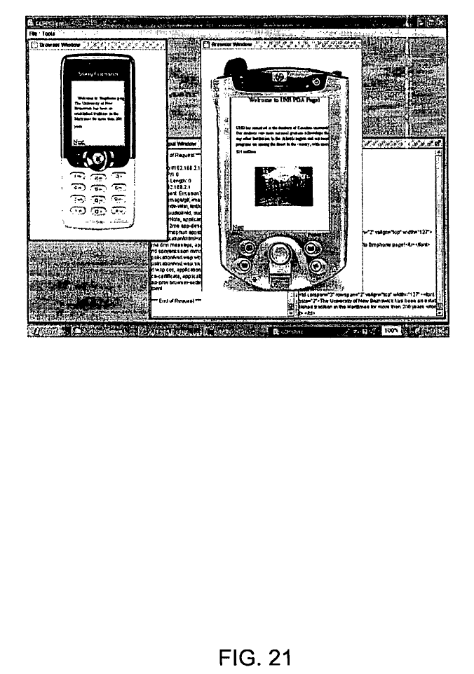

The test was performed on the FACADE test client. FIG. 20 is the screen shot of the adaptation result for the desktop page. FIG. 21 is the screen shot of the adaptation result for the PDA page and the Smartphone page.

Pagination and navigation tags were also tested. They were recognized by the FACADE proxy and the proxy was able to forward the proper page whenever the navigation request was sent.

### Multi-Source Mode

When the program is set to multi-source mode, it outputs regular HTML web pages for each device separately. These web pages do not require an adaptation engine and therefore can be used in current non-adaptive World Wide Web environments. However, the pagination feature will be disabled since no extension tags will be embedded. Only one page of each device window can be created.

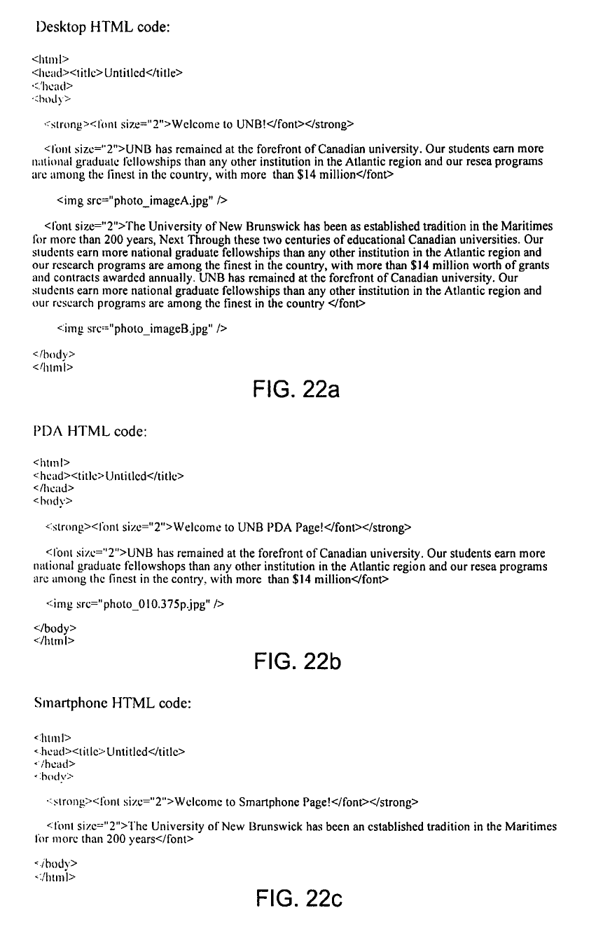

FIGS. 22a-c illustrate the web page code generated for the Desktop, PDA and Smartphone devices in HTML format, respectively.

The HTML code was uploaded to a Tomcat server that was running on a desktop machine, and then using an IPAQ Pocket PC to connect to this Tomcat server through the wireless connection. The connection was successful and the page was downloaded and displayed properly.

### Nested Table Example

Nested Tables were chosen for good compatibility, although they are not very efficient. The code becomes very long since tables are divided into numerous small cells.

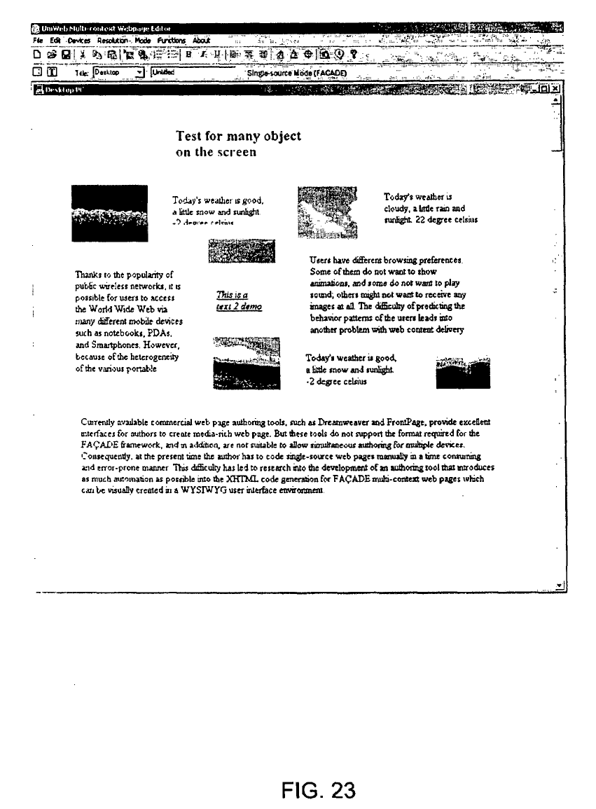

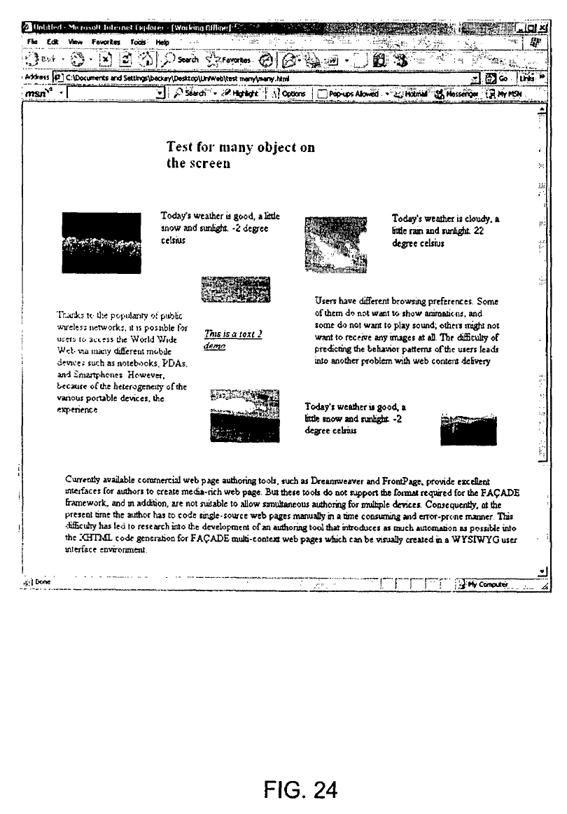

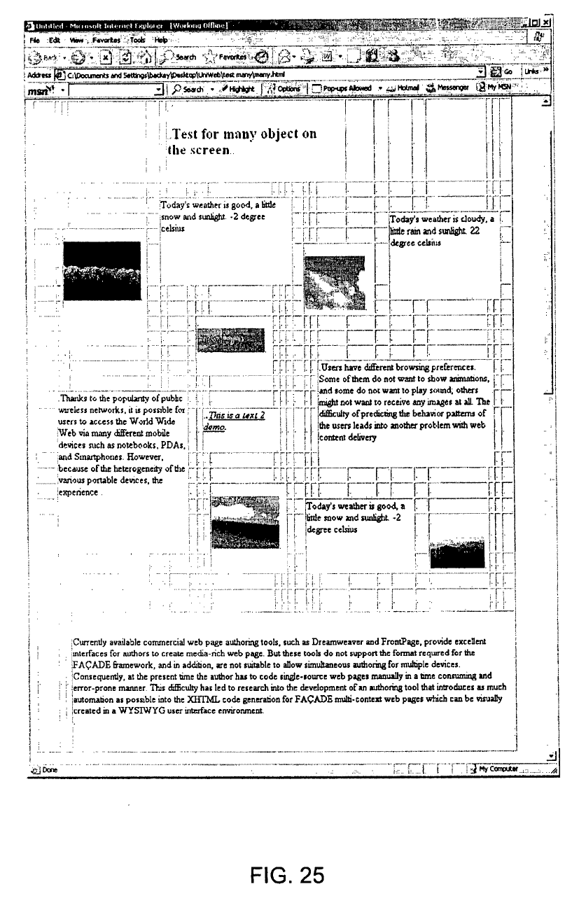

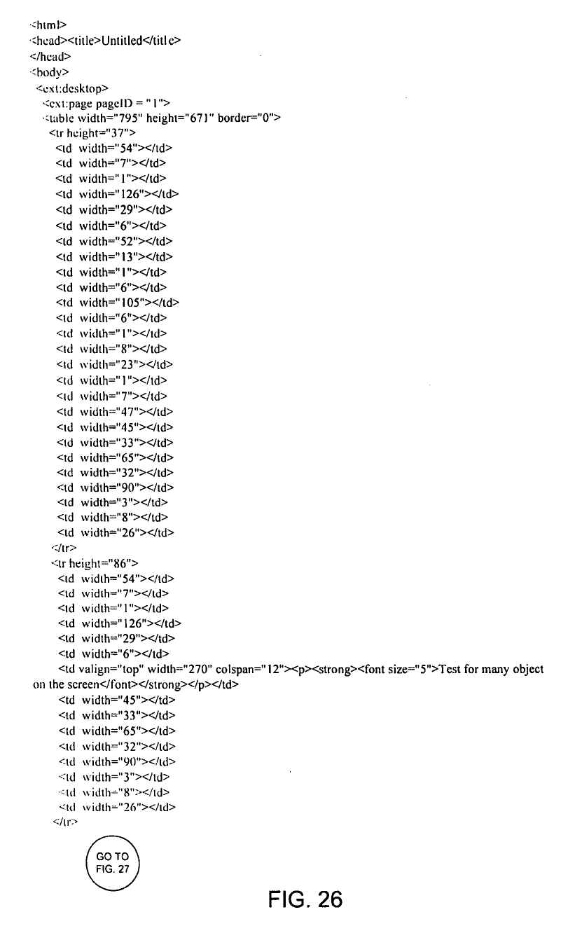

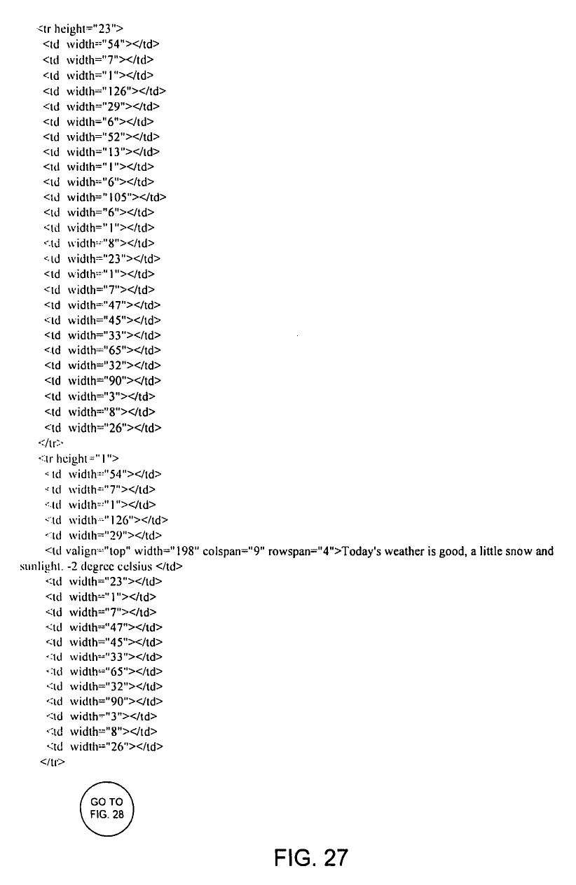

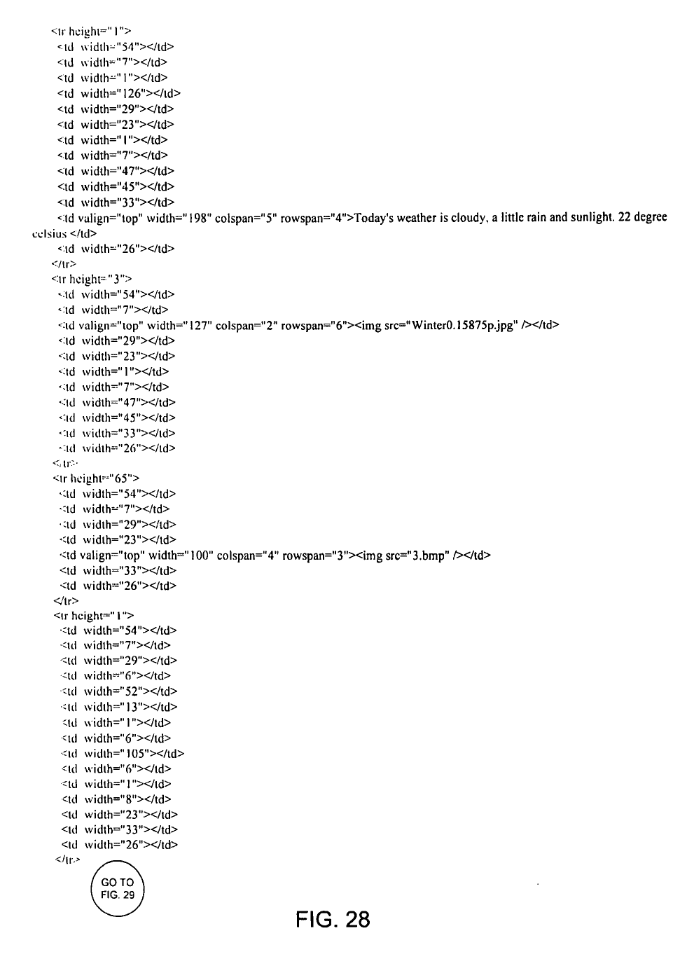

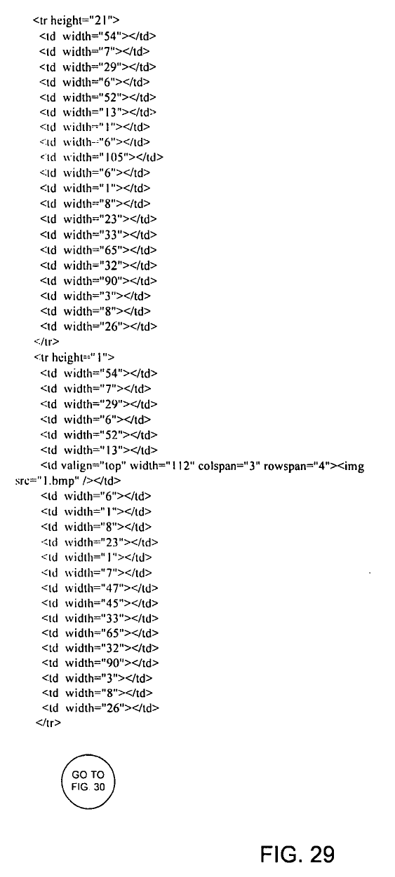

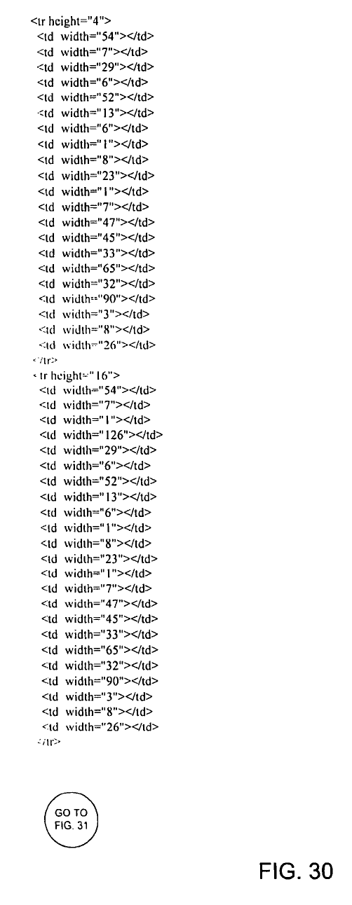

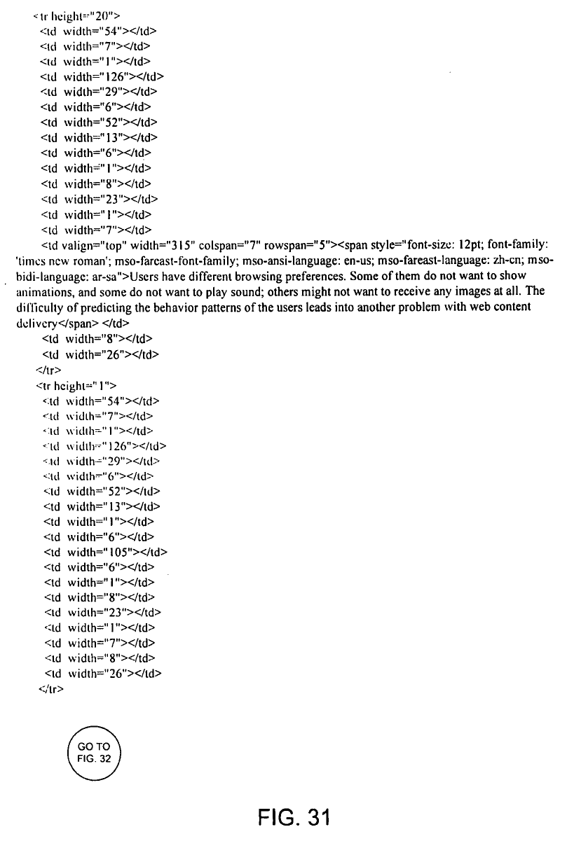

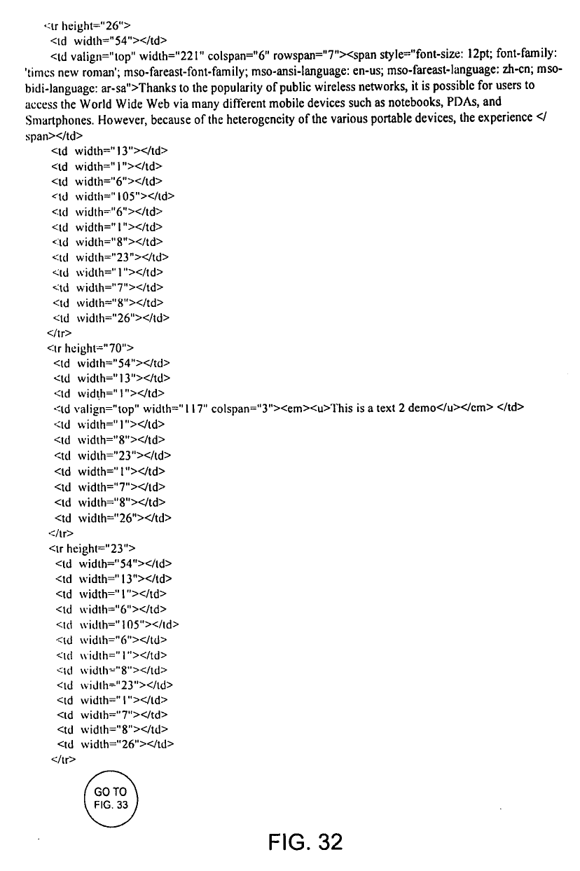

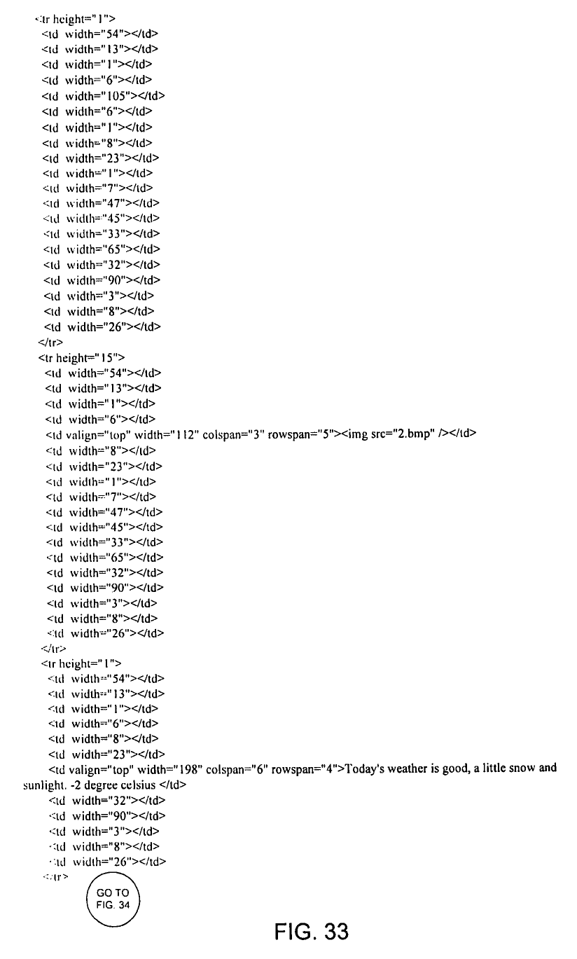

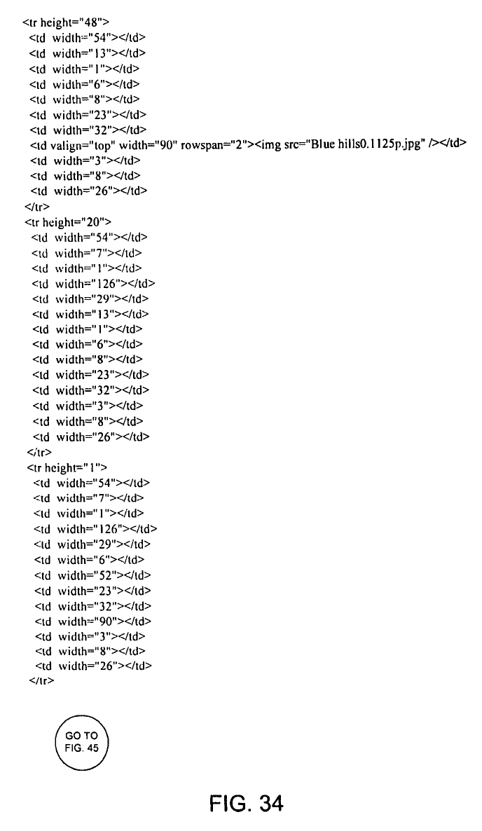

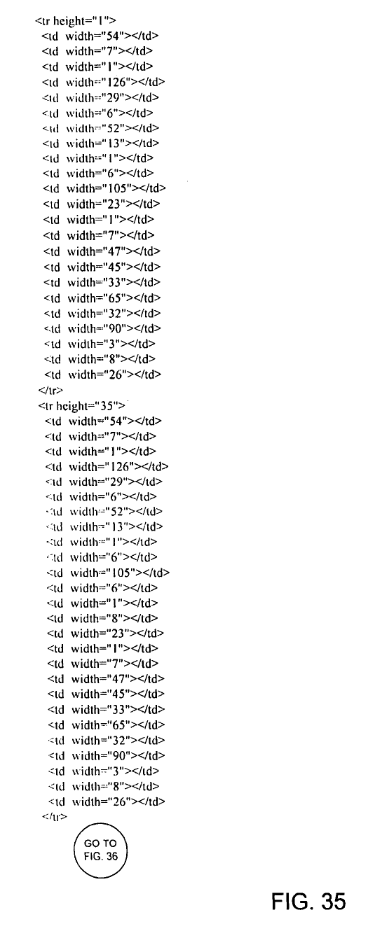

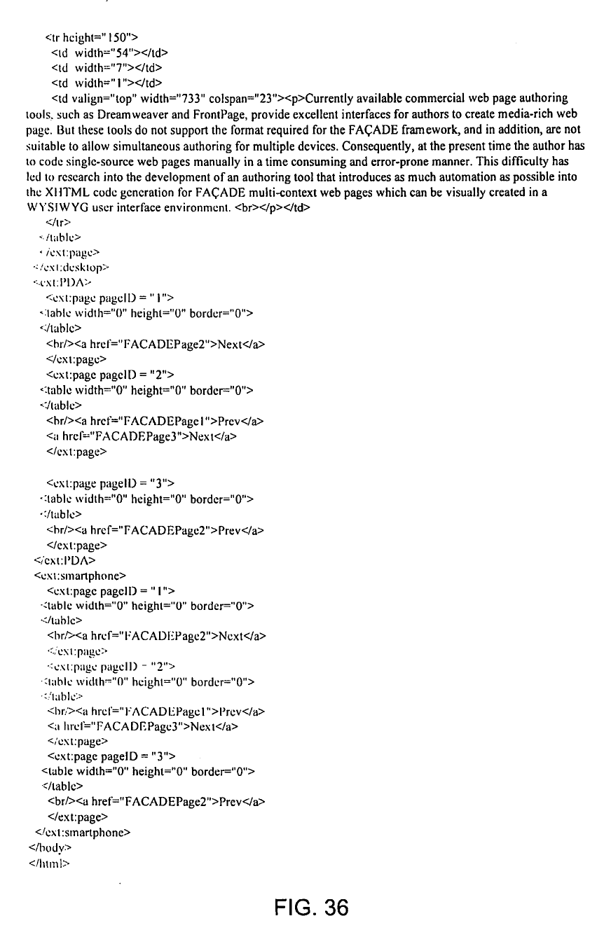

To illustrate this, an example is provided wherein many objects are placed in a device window. FIG. 23 shows a device window which is editing on a page with many objects. FIG. 24 shows the web page rendered on a desktop web browser using nested tables with a hidden border. FIG. 25 shows the web page rendered on a desktop web browser using nested tables with a visible border.

The code becomes very long since tables are divided into numerous small cells. FlGS. 26-36 show an example code page of the nested tables shown in FIGS. 23-25.

### Alternatives To FACADE

Context-aware frameworks for adaptive delivery of documents follow various implementation approaches of which FACADE and its corresponding code page structure are but one example. It is anticipated that alternatives to FACADE and its corresponding code page structure may be used by persons of ordinary skill in the art, and the use of any such alternatives to arrive at the advantages of the present invention are considered to be obvious in view of the present disclosure. For example, given a structure for code pages (such as another XHTML tag set, or secondary language like Java, VB, or like compatible with Websphere or the like), the advantages of the invention may be arrived at by making corresponding modifications to the code generation engine disclosed herein so that it generates code using the given code page structure. Any such variations are considered to be obvious in view of the present disclosure.

Alternatives to FACADE and structures for code page documents documents include but are not limited to those frameworks and code page structures described in the following references, all of which are incorporated herein by reference:
US20050039108A1 entitled “Fast tag entry in a multimodal markup language editor”, describes the process of inserting defined tags in the code of mark-up language based media documents by a semi-automatic method that forces correct syntax, as an aid to creating error-free code, but does not deal with a multi-context tool to help create entire documents suitable for adaptation to multiple contexts;
US20050086262A1 entitled “Method and apparatus for WAP and XHTML site management”, describes a publishing framework for documents suitable for different devices, and the separate use of content and templates is promoted to build documents for target devices, but does not deal with the author creating contents or templates, and does not describe an integrated authoring tool for multi-context authoring of web documents;
US20030158969A1 entitled “Authoring of media content and dissemination via an information technology network”, describes a method of context-adaptation similar to FACADE, wherein a method of authoring of media documents is described in terms of the promoted structure in the documents, but the actual activities of creating the device-independent code of media by an author-specific tool are not described;
U.S. Pat. No. 6,928,617 entitled “Segmentation of views for simplified navigation on limited device”, describes the structure of documents with a plurality of attributes for different contexts, wherein the use of (cascading) style sheets is promoted, but his is not related to the efficient authoring of these documents; and

U.S. Pat. No. 6,857,102 entitled “Document re-authoring systems and methods for providing device-independent access to the world wide web”, describes a method of structuring device-independent documents for rendering on multiple devices, but is not concerned with the creation of these documents by an author using a special authoring tool.

The above-described embodiments of the present invention are intended to be examples only. Those of skill in the art may effect alterations, modifications and variations to the particular embodiments without departing from the scope of the invention. Which is set forth in the claims.

What is claimed is:

1. A web page authoring tool apparatus, comprising:
a user interface module for manipulatively authoring at least two context-dependent views of the web page, each view including web content; and
a code page generation module for automatically generating a context-aware code page from the at least two context-dependent views of the web page;
wherein rendering cues for presentation of the web page are embedded by the code page generation module according to at least one feature of the web content in each of the at least two context-dependent views, to subsequently aid in at least one of a qualitative aspect of dynamic content adaptation of the context-aware code page and a static content adaptation of the context-aware code page in rendering the web page.

2. The apparatus as recited in claim 1, wherein the at least one feature includes a semantics of the web content.

3. The apparatus as recited in claim 1, wherein the at least one feature includes a relevance of the web content.

4. The apparatus as recited in claim 1, wherein the at least one feature includes a layout of the web content.

5. The apparatus as recited in claim 1, wherein the at least one feature includes a specification to allow adaptation.

6. The apparatus as recited in claim 1, wherein the at least one feature includes a specification to prevent adaptation.

7. The apparatus as recited in claim 1, wherein the at least one feature includes an adaptation unit specification.

8. The apparatus as recited in claim 1, wherein the at least one feature includes pagination.

9. The apparatus as recited in claim 1, wherein the at least one feature includes navigation.

10. The apparatus as recited in claim 1, wherein the at least one feature includes an inclusion/exclusion specification whereby web content is either excluded or included based on context parameters.

11. The apparatus as recited in claim 1, wherein the at least one feature includes a selection tag.

12. The apparatus as recited in claim 1, wherein the at least one qualitative aspect includes semantic fidelity of the content adaptation.

13. The apparatus as recited in claim 1, wherein the at least one qualitative aspect includes usability of the content adaptation.

14. The apparatus as recited in claim 1, wherein at least one of the at least two views is a WYSIWYG view.

15. The apparatus as recited in claim 1, wherein the context is the context of the delivery of the web page and includes any information that can be used to characterize the situation of an entity.

16. The apparatus as recited in claim 15, wherein the context includes device capabilities.

17. The apparatus as recited in claim 15, wherein the context includes network conditions.

18. The apparatus as recited in claim 15, wherein the context includes user preference.

19. The apparatus as recited in claim 1, wherein the context-aware code page is a single-source code page.

20. The apparatus as recited in claim 1, wherein the static adaptation of the context-aware code page results in a multi-source code page.

21. The apparatus as recited in claim 1, wherein the code generation module produces a project file as an intermediate product to obtain the context-aware code page.

22. The apparatus as recited in claim 1, wherein the context-aware code page is an XHTML page.

23. The apparatus as recited in claim 1, wherein the context-aware code page comprises an HTML page.

24. The apparatus as recited in claim 1, wherein the code generation module comprises a GI/XHTML Code Engine.

25. The apparatus as recited in claim 1, wherein the user interface module comprises a Drawing Engine.

26. The apparatus as recited in claim 1, wherein the user interface module comprises an Action Listener.

27. The apparatus as recited in claim 1, wherein the code generation module comprises an Object Container.

28. The apparatus as recited in claim 1, wherein the user interface module comprises at least one WebBrowser Control.

29. A web page authoring tool method, comprising the steps of:
providing a user interface module for manipulatively authoring at least two context-dependent views of the web page, each view including web content; and
providing a code page generation module for automatically generating a context-aware code page from the at least two context-dependent views of the web page;
wherein rendering cues for presentation of the web page are embedded by the code page generation module according to at least one feature of the web content in each of the at least two context-dependent views, to subsequently aid in at least one of a qualitative aspect of dynamic content adaptation of the context-aware code page and a static content adaptation of the context-aware code page in rendering the webpage.

30. The method as recited in claim 29, further comprising the step of generating the code page dynamically whenever a user requests it.

31. The method as recited in claim 29, further comprising the step of providing web page editing functions.

32. The method as recited in claim 31, wherein the web page editing functions include at least one of changing font, changing color, bold, italic, underline and justify (left, center and right).

33. The method as recited in claim 31, wherein the web page editing functions include inserting a Hyper-link.

34. The method as recited in claim 31, wherein the web page editing functions include inserting an image.

35. The method as recited in claim 31, wherein the web page editing functions include inserting a textbox.

36. The method as recited in claim 35, wherein the web page editing functions include editing the textbox.

37. The method as recited in claim 29, further comprising the step of providing a Glyph.

38. The method as recited in claim 37, wherein the Glyph defines attributes of an image.

39. The method as recited in claim 37, wherein the Glyph defines attributes of a textbox.

40. The method as recited in claim 37, further comprising the step of performing hit detection on the Glyph.

41. The method as recited in claim 37, further comprising the step of drawing the Glyph on a screen.

42. The method as recited in claim 37, further comprising the step of highlighting the Glyph on a screen.

43. The method as recited in claim 37, further comprising the step of erasing the Glyph from a screen.

44. The method as recited in claim 37, further comprising the step of returning the content of the Glyph.

45. The method as recited in claim 37, further comprising the step of moving the Glyph to a new location on a screen.

46. The method as recited in claim 37, further comprising the step of resizing the Glyph to a new set of dimensions.

47. The method as recited in claim 37, further comprising the step of recording an interaction of an author with a device window.

48. The method as recited in claim 47, wherein the interaction includes an object drag and drop action.

49. The method as recited in claim 47, wherein the interaction includes a movement of an object action.

50. The method as recited in claim 47, wherein the interaction includes a resizing of an object action.

51. The method as recited in claim 47, wherein the interaction includes a text entry action.

52. The method as recited in claim 47, wherein the interaction includes a general object editing action.

53. The method as recited in claim 29, further comprising the step of generating the code page.

54. The method as recited in claim 53, wherein the generating code page step further comprising the act of serializing objects.

55. The method as recited in claim 53, wherein the generating code page step further comprising the act of extracting attributes from objects and saving them in text format.

56. The method as recited in claim 55, wherein the text file comprises a field which represents a device.

57. The method as recited in claim 56, wherein the field comprises an object representation.

58. The method as recited in claim 57, wherein the object representation comprises an attribute.

59. The method as recited in claim 57, wherein the object representation represents a textbox.

60. The method as recited in claim 57, wherein the object representation represents an image.

61. The method as recited in claim 57, wherein the object representation represents a combination of objects.

62. The method as recited in claim 58, wherein the attribute is the type of the object.

63. The method as recited in claim 58, wherein the attribute is the location of the object.

64. The method as recited in claim 58, wherein the attribute is the size of the object.

65. The method as recited in claim 58, wherein the attribute is the content of the object.

66. The method as recited in claim 58, wherein the attribute is the owner of the object.

67. The method as recited in claim 58, wherein the attribute includes a sub-unit.

68. The method as recited in claim 53, wherein the code page is a single-source code page.

69. The method as recited in claim 68, wherein the single-source code page is in XHTML.

70. The method as recited in claim 53, wherein the code page is a multi-source code page is in HTML.
